(19) United States
(12) Patent Application Publication
(10) Pub. No.: US 2021/0360366 A1
(43) Pub. Date: Nov. 18, 2021

(54) PROXIMITY-BASED CONTACT TRACING SYSTEM

(71) Applicant: Hubbell Incorporated, Shelton, CT (US)

(72) Inventors: Christopher Lane Bailey, Shelton, CT (US); Timothy Eugene Willis, Shelton, CT (US); Adam Joseph Clark, Greenville, SC (US); Walter Lawrence Bretzer, Shelton, CT (US)

(21) Appl. No.: 17/320,163

(22) Filed: May 13, 2021

Related U.S. Application Data
(60) Provisional application No. 63/050,437, filed on Jul. 10, 2020.
(60) Provisional application No. 63/024,056, filed on May 13, 2020.

(51) Int. Cl. H04W 4/02; H04W 4/80; H04W 88/08; G08B 7/06

(52) U.S. Cl. CPC H04W 4/023; H04W 4/027; G08B 7/06; H04W 88/08; H04W 4/80

(57) ABSTRACT

The present disclosure provides embodiments of mobile devices designed to be worn by a person and configured to detect when another mobile device is within a predefined distance and to provide the wearer with an indication that another mobile device is within the predefined distance. The mobile device includes a sealed housing, a clip member, a UWB detector and at least one indicator. The housing has a front housing portion, a rear housing portion and at least one cavity for receiving internal components. The clip member includes a mounting bracket used to affix the clip member to either the front housing portion or the rear housing portion, and a clip is used to permit mobile device to be worn by a person. The UWB detector circuit is located within the at least one cavity and receives signals from at least one other mobile device. The UWB detector circuit also calculates a distance between the mobile device and the at least one other mobile device. The at least one indicator is used to provide at least an audible, haptic or visual indication when the distance between the mobile device and the at least one other mobile device is calculated to be within a predetermined distance.

### CROSS REFERENCE TO RELATED APPLICATIONS

The present disclosure is based on and claims benefit from co-pending U.S. Provisional Patent Application Ser. No. 63/050,437 filed on Jul. 10, 2020 entitled “Proximity-Based Contact Tracing Solution” and co-pending U.S. Provisional Patent Application Ser. No. 63/024,056 filed on May 13, 2020 entitled “Proximity-Based Contact Tracing Solution” the entire contents of each are incorporated herein by reference.

### BACKGROUND

### Field

The present disclosure relates to a system for tracing individuals or objects based on proximity.

### Description of the Related Art

When attempting to contain the spread of a particular infectious disease, only a few mitigation options may be available. In the case of the infectious disease having no cure and no vaccine, measures to prevent the spread of the disease may be limited to quarantine or contact tracing. Although ultimately effective, quarantine in a hospital may lead to unintended consequences like contraction of the disease by hospital staff, decrease in hospital visits for the uninfected general public, imbalanced usage of hospital supplies and disruption of the related supply chain. Unintended consequences to the uninfected public may occur such as decreased visits to the hospital for conditions not related to the particular infectious disease. Further, self-quarantine may have unintended effects on mental and physical health. Proximity tracing, localization, and tracing of individuals or objects may be useful in controlling, or even preventing, the spread of such an infectious disease. In particular, proximity tracing may be useful when attempting to track and prevent the spread of a disease that may be spread through approximate contact of individuals.

Contact tracing relates to tracking when and where individuals or other objects are within a predetermined proximity to other individuals in space and time. Such tracking may occur in a number of manners or modes including real-time tracking of mobile phones and devices, community reporting, recording of mobile phone relative location coincidence, self-reporting of symptoms, cellular triangulation, QR code tracking, hotspot highlighting, general transmission probabilities calculation, and more. However, many of these methods are involuntary for the tracked individual or object, are unfocused, produce an inaccurate, inconsistent, or incomplete record, or potentially infringe of various privacy rights. A method of tracking for the purpose of proximity tracing that maintain privacy rights intact in some or all respects while allowing the tracking agency to obtain a substantially complete record of the tracked individual or object's movements and proximity to other objects or individuals is needed. Such a method could be used for several reasons, including but not limited to determining areas of congregation and/or congestion and ultimately assisting in maintaining appropriate distances between individuals to reduce the risk of spreading a virus or disease.

### SUMMARY

In a number of embodiments, a fixed proximity device may be configured to control access to a particular area of a premises by requiring authentication or permission to access the particular area by use of a mobile proximity device. The mobile proximity device may store and update data about itself and its interactions with fixed proximity devices, other mobile proximity devices or secondary proximity devices. The mobile proximity device may also be constructed and arranged to have this data updated by fixed proximity devices, other mobile proximity devices or secondary proximity devices during such interactions. The fixed proximity device may be configured to read at least some of the mobile proximity device data in response to the mobile proximity device entering the proximity of the fixed proximity device. The fixed proximity device may grant the wearer of a mobile proximity device access to the controlled area upon authentication of the mobile proximity device and may also transmit any data read from the mobile or portable device to the administration system, e.g., a central computing and/or storage system. Secondary proximity devices within the controlled premises may be configured to also read data from or update data on mobile proximity devices and similarly transmit pertinent data from this interaction to the administration system. Secondary proximity devices may be a mobile device or a fixed device. The administration system, e.g., a central computing and/or storage system, may analyze data transmitted to it by fixed proximity devices and secondary proximity devices on the premise and correlate the data according to an algorithm configured to produce useful tracking data about individuals wearing mobile proximity devices that enter the controlled premises. Visualization software may be used to present this data intuitively on a capable device, such as but not limited to a mobile phone or a desktop computer, should an assessment of the movements and actions of such individuals wearing the mobile proximity devices be initiated.

In another exemplary embodiment, the mobile proximity device includes a housing, a UWB detector circuit and at least one indicator. The housing has a front housing portion, a rear housing portion and at least one cavity for receiving internal components. The UWB detector circuit is positioned within the at least one cavity in the housing. The UWB detector circuit is configured to receive signals from at least one other mobile proximity device and for calculating a distance between the mobile proximity device and the at least one other mobile proximity device. The UWB detector circuit may also be selectively enabled or powered according to a predefined schedule to conserve battery power. The at least one indicator used to provide at least an audible, haptic or visual indication when the distance between the mobile proximity device and the at least one other mobile proximity device is calculated to be within a predetermined distance. The predetermined distance may be between about 1 foot and about 10 feet.

The mobile proximity device may also include a clip member having a mounting bracket used to affix the clip member to either the front housing portion or the rear housing portion of the housing. The clip member also includes a clip used to removably attach the clip member to a wearer of the mobile proximity device. In another exemplary embodiment, the mobile proximity may include a bracket attached to the housing and configured to receive a strap or lanyard. The mobile proximity device may also include accelerometer circuitry used to detect if the mobile proximity device is moving or stationary. When the accelerometer circuitry detects that the proximity device is stationary, the mobile proximity device operates in a low power state. When the accelerometer circuitry detects that the proximity device is moving, the mobile proximity device operates in a normal operating state performing calculations of the distance between the mobile proximity device and the at least one other mobile proximity device. The mobile proximity device may also include a controller circuit within the housing that logs each instance where the distance between the mobile proximity device and the at least one other mobile proximity device is calculated to be within a predetermined distance.

In another exemplary embodiment, the mobile proximity device includes a housing, a UWB detector circuit, at least one indicator and a bracket attached to the housing and configured to receive a strap or lanyard. The housing has a front housing portion, a rear housing portion and at least one cavity for receiving internal components. The UWB detector circuit is positioned within the at least one cavity in the housing. The UWB detector circuit is configured to receive signals from at least one other mobile proximity device and for calculating a distance between the mobile proximity device and the at least one other mobile proximity device. The UWB detector circuit may also be selectively enabled or powered according to a predefined schedule to conserve battery power. The at least one indicator used to provide at least an audible, haptic or visual indication when the distance between the mobile proximity device and the at least one other mobile proximity device is calculated to be within a predetermined distance. The predetermined distance may be between about 1 foot and about 10 feet.

The present disclosure also provides embodiments of proximity detection systems. In one exemplary embodiment the proximity detection system includes a plurality of mobile proximity devices, at least one fixed proximity device and at least one administrative system. Each of the plurality of mobile proximity devices includes a housing, a UWB detector circuit and at least one indicator. The housing has a front housing portion, a rear housing portion and at least one cavity for receiving internal components. The UWB detector circuit is positioned within the at least one cavity in the housing. The UWB detector circuit is configured to receive signals from at least one other mobile proximity device and for calculating a distance between the mobile proximity device and the at least one other mobile proximity device. The UWB detector circuit may also be selectively enabled or powered according to a predefined schedule to conserve battery power. The at least one indicator is used to provide at least an audible, haptic or visual indication when a proximity event is detected by the UWB detector circuit. A proximity event is when the distance between the mobile proximity device and the at least one other mobile proximity device is calculated to be within a predetermined distance. The predetermined distance may be between about 1 foot and about 10 feet. The at least one fixed proximity device is configured to wirelessly communicate with each of the plurality of mobile proximity devices such that each of the plurality of mobile proximity devices transmits to the at least one fixed proximity device each detected proximity event. The at least one administrative system is configured to wirelessly communicate with the at least one fixed proximity device such that the at least one fixed proximity device transmits to the at least one administrative system each detected proximity event. Such communication between the administrative system and the fixed proximity device may be by way of intermediary devices and/or networks, such as Wi-Fi access points.

Other aspects of the disclosure will become apparent by consideration of the detailed description and accompanying drawings.

### BRIEF DESCRIPTION OF THE DRAWINGS

FIG. 1 depicts a schematic representation of a proximity system according to a number of embodiments;

FIG. 2 depicts a schematic representation of a proximity system according to a number of embodiments wherein location detection and transmission is performed by additional connected devices;

FIG. 3 depicts a block representation of an exemplary embodiment of a proximity system according to the present disclosure;

FIG. 3A depicts a block representation of another exemplary embodiment of a proximity system according to the present disclosure;

FIG. 3B depicts a block representation of another exemplary embodiment of a proximity system according to the present disclosure;

FIG. 4 is a block representation of a device discovery function of the proximity system according to the present disclosure;

FIG. 5 is a block representation of a device ranging function of the proximity system according to the present disclosure;

FIG. 6 is a block representation of a device alarming and registration function of the proximity system according to the present disclosure;

FIG. 7 is a block representation of a device registration transmission function of the proximity according to the present disclosure;

FIG. 8 is a front perspective view of an exemplary embodiment of a mobile proximity device according to the present disclosure;

FIG. 9 is a rear perspective view of the mobile proximity device of FIG. 8;

FIG. 10 is a front elevation view of the mobile proximity device of FIG. 8;

FIG. 11 is a rear elevation view of the mobile proximity device of FIG. 8;

FIG. 12 is a side elevation view of the mobile proximity device of FIG. 8;

FIG. 13 is a top plan view of the mobile proximity device of FIG. 8;

FIG. 14A is an exploded rear perspective view of the mobile proximity device of FIG. 5;

FIG. 14B is an exploded perspective view of a rear portion of the mobile proximity device of FIG. 14A;

FIG. 15 is a front perspective view of another exemplary embodiment of a mobile proximity device according to the present disclosure;

FIG. 16 is a rear perspective view of the mobile proximity device of FIG. 15;

FIG. 17 is a front elevation view of the mobile proximity device of FIG. 15;

FIG. 18 is a rear elevation view of the mobile proximity device of FIG. 15;

FIG. 19 is a side elevation view of the mobile proximity device of FIG. 15;

FIG. 20 is a top plan view of the mobile proximity device of FIG. 15;

FIG. 21 is a front perspective view of the mobile proximity device of FIG. 15, illustrating a strap connected to the mobile proximity device;

FIG. 22 is a schematic diagram of exemplary power supply circuitry for the mobile proximity device according to the present disclosure;

FIG. 23 is a schematic diagram of exemplary ultra-wideband detector circuitry for the mobile proximity device according to the present disclosure;

FIGS. 24A and 24B are a schematic diagram of exemplary indicator generator circuitry for the mobile proximity device according to the present disclosure;

FIGS. 25A and 25B are a schematic diagram of exemplary controller circuitry for the mobile proximity device according to the present disclosure;

FIG. 26 is a schematic diagram of exemplary accelerometer circuitry for the mobile proximity device according to the present disclosure;

FIG. 27 is an exemplary indicator table for various operational states of the mobile proximity device according to the present disclosure; and

FIG. 28 is an exemplary alarm mode table for various alarm states of the mobile proximity device according to the present disclosure.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. As used herein a “connected” device may refer to a device that is constructed and arranged to communicate with one or more other devices.

The present disclosure includes embodiments of proximity systems that can register and store data of incidents when individuals are within a predefined distance of each other and/or within a predefined distance of a fixed location within a predefined space. A proximity system according to the present disclosure may include one or more proximity devices. A proximity device according to the present disclosure may be a stand-alone mobile proximity device or included in multi-function mobile proximity device. A proximity device according to the present disclosure may also be a stand-alone fixed proximity device or included in a multi-function fixed proximity device. A stand-alone mobile proximity device according to the present disclosure includes a housing or casing that is generally portable or non-stationary in nature and capable of being hand-held or worn by an individual or disposed on an object. A non-limiting example of a stand-alone mobile proximity device is mobile proximity device that performs its function without the need of another device, computer or connection. Non-limiting examples of stand-along mobile proximity devices include security authentication accessories, such as but not limited to, security authentication tags or badges, security authentication badge holders, armbands and lanyard. A multi-function mobile proximity device according to the present disclosure includes a mobile proximity device that performs multiple functions that may be different or independent from each other or that may interoperate to perform one or more functions. Non-limiting examples of multi-function mobile proximity devices include smartphones and tablets. Collectively, stand-alone and multi-function mobile proximity devices according to the present disclosure may also be referred to herein as the “mobile proximity devices” in the plural and the “mobile proximity device” in the singular. It is also noted that a mobile proximity device according to the present disclosure may also be referred to herein as “pass devices” in the plural and a “pass device” in the singular.

A mobile proximity device according to the present disclosure also includes a power source and a module or system that includes electrical hardware and/or software capable of transmitting or receiving data via over-the-air transmission or by electrical communication. The module or system is also equipped with hardware and/or software for measuring and/or generating data for transmission to one or more other mobile proximity devices or to one or more fixed proximity devices. Non-limiting examples of the data transmitted by a mobile proximity device includes, but is not limited to, proximity event data associated with one or more close proximity contacts of a mobile proximity device with one or more other mobile proximity devices, system data about the mobility proximity device such as a set distance threshold, diagnostic information, battery charge state, current alarm mode, fixed proximity device or access point to which the mobile proximity devices is connected. Non-limiting examples of such proximity event data include, a minimum distance between two mobile proximity devices in for example inches, an average distance between two mobile proximity devices in for example inches, a contacting mobile proximity device address, e.g., the UWB address, and a duration of the proximity event in, for example, seconds.

As noted above, the mobile proximity devices according to the present disclosure may include a housing or casing that is generally portable or non-stationary in nature and capable of being hand-held or worn by an individual or disposed on an object. For ease of description, such an individual wearing a mobile proximity device may also be referred to herein as a “wearer” in the singular and as “wearers” in the plural. In a number of embodiments, a mobile proximity device may be housed in an enclosure constructed of polycarbonate or an antimicrobial ABS plastic. The mobile proximity device may be equipped with a buzzer or speaker for delivering audio warnings or feedback to the wearer of the mobile proximity device. The mobile proximity device may further be equipped with a vibration motor for delivering haptic feedback or warnings to the wearer. The mobile proximity devices also include a source of electrical power, such as a battery. The battery may be of any type of battery suitable to be included in an enclosure, and may be rechargeable. The battery of the mobile proximity devices may be constructed and arranged to be recharged by a power source constructed and arranged to generate charge from a renewable source, such as but not limited to a gyroscopic generator, a piezoelectric generator, a solar panel, a wind-driven generator, a thermoelectric generator and so on. Any source of power onboard the mobile proximity device may be configured to generate power as a result of the movement, biology, or biological byproducts such as but not limited to the body heat of the wearer. The mobile proximity device may also be configured to sleep or enter a power saving state during certain times, in certain areas, or when the mobile proximity device detects that it is sitting idle.

The mobile proximity devices of the present disclosure may also include entry-authorization components and/or software, such as but not limited to near-field technology, smart card technology, an RFID tag, a magnetic strip, a programmable microcontroller configured to execute authorization software, a radio such as a Bluetooth radio, an ID card, etc. The mobile proximity devices may include proximity and location detection hardware and/or software, such as but not limited to a GPS tracker, a Bluetooth chip or other radio chip, a Wi-Fi transceiver, or ultra-wideband technology. Additionally, the mobile proximity devices may be constructed and arranged to detect footfall, traffic patterns, congregation or dwelling of wearers. Further, the mobile proximity device may be constructed and arranged to collect data pertaining to the wearers of other mobile proximity devices that the wearer of the mobile proximity device has been in close proximity to at the time when such contacts occur. The mobile proximity device may also be constructed and arranged to collect, store and/or transfer data, such as but not limited to, data associated with the mobile proximity device's orientation, the unique identifier of the mobile proximity device, the signal strength of the transmitting mobile proximity device, the battery power level of the mobile proximity device, the type of mobile proximity device, the type of device with which the mobile proximity device is communicating and/or the date and time of interaction when the mobile proximity device is used for authentication or comes into proximity with another mobile proximity device or fixed proximity device. The mobile proximity device may be configured to update this data as the real-world circumstances from which the data is drawn change.

In another exemplary embodiment, the mobile proximity devices according to the present disclosure may be a powered electronic device that includes at least one onboard radio module for wireless communication. The radio modules of the mobile proximity devices may be modules, such as but not limited to, a Bluetooth radio module, an ultra-wideband radio module, a near-field communication radio module, an RFID radio module, a Wi-Fi radio module, or any other known radio module for over-the-air communications or data transfer. The mobile proximity devices may be configured to use any onboard radio modules to communicate wirelessly with other mobile proximity devices or fixed proximity devices. The mobile proximity devices may also be configured to use any onboard radio modules sequentially or concurrently to achieve proper pairing with other mobile proximity devices or fixed proximity devices according to the requirements of those devices. As a non-limiting example, a mobile proximity device may be configured to achieve a wireless handshake operation with another mobile proximity device using a first radio module according to a first protocol, and to subsequently engage in serial or other prolonged communications with the other fixed proximity devices by using a second radio module according to a second protocol.

In another exemplary embodiment, the mobile proximity devices according to the present disclosure may be a powered electronic device including a controller and memory, and may be programmable to execute firmware as well as software. The mobile proximity devices may be individually programmable and updatable. As a non-limiting example, each mobile proximity device may be programmed with and constructed and arranged to execute unique firmware or software. A mobile proximity device according to the present disclosure may also be constructed and arranged to accept over-the-air updates to software or firmware. The mobile proximity device may further be configured to accept such updates when the mobile proximity device is positioned within a predetermined proximity of a controlled premises or within the proximity of a particular device or type of device such as but not limited to a fixed proximity device.

In another exemplary embodiment, the mobile proximity device according to the present disclosure may be implemented on a mobile platform, such as a mobile phone, tablet or other smart mobile platform. Implementation of the mobile proximity device according to the present disclosure on a mobile platform may be accomplished via the use of a software application that accesses appropriate hardware of the mobile platform for interacting with a fixed proximity device, another mobile proximity device, or an additional connected device. In some cases, the application implementation of the mobile proximity device may be web-based. Additionally, if the application implementation of the mobile proximity device is installed on a mobile platform, options on the mobile platform may allow the application to access data previously collected by other and older installed applications and organize it appropriately to be analyzed by an analytics algorithm included in the mobile proximity device of the present application.

In a number of embodiments, triggers may be defined for the mobile proximity device according to the present disclosure. The triggers may be circumstances or events that may cause the mobile proximity device to be induced to begin storing, updating or/and communicating data. Trigger areas, times, dates, etc. may be defined for mobile proximity devices at a central storage or processing system such as but not limited to a data center, a cloud computing service, or a cloud storage service. Trigger areas may be defined by static or dynamic bounds such as but not limited to geofences, geographical coordinates, relative positions such as but not limited to a feet or meters radius from a geographical coordinate, fixed proximity device, or mobile proximity device carrier. Trigger times may be defined relatively as well. As a non-limiting example, a trigger start time may be tied to a defined but mutable event time such that if the start time for the event is redefined, the trigger time need not be redefined and may automatically adjust based on the dynamically-tied definition of the trigger time. In a number of embodiments, the mobile proximity device may be constructed and arranged to produce haptic or audio feedback within a trigger area or during a trigger time if the mobile proximity device senses that the mobile proximity device carrier is causing an increased risk of distributing a contagion, parasite, radiation, toxic chemical, etc.

In a number of embodiments, a mobile proximity device may be configured to communicate with, exchange data with, update the data of, or have its own data updated by another mobile proximity device, a fixed proximity device, or an additional device or secondary proximity device based upon circumstances. As a non-limiting example, mobile proximity devices may be configured to only register as having been in approximate contact with one another if the mobile proximity devices entered a pre-defined proximity of one another (e.g., a first mobile proximity device detects that a second mobile proximity device is within at least six feet of the first mobile proximity device). Mobile proximity devices may also be configured to calculate the distance between two mobile proximity devices. This calculation may be triggered by the proximity of a first and second mobile proximity device, and the result of the calculation may be stored on both the first and second mobile proximity device. To calculate the distance between the first and second mobile proximity device, a Time of Flight (ToF) method may be used. It is noted that the Time of Flight method may also be referred to as Two-Way Ranging (TWR). In an exemplary embodiment of TWR, the amount of time for a radio signal to travel from a first mobile proximity device to a second mobile proximity device may be used to calculate the distance between the first mobile proximity device and the second mobile proximity device. Since radio frequency energy may propagate at the constant speed of light, the TWR method directly correlates to the distance between the first and second mobile proximity device. More specifically, the time at which the first mobile proximity device sends a radio signal and the time that the signal arrives at the second mobile proximity device may be noted, and a difference in the time of transmission by the first mobile proximity device and the time of receipt by the second mobile proximity device multiplied by the speed of light provides the distance between the first mobile proximity device and the second mobile proximity device. TWR may be executed with other techniques, for example, by calculating the round trip distance. Other techniques may be used to calculate the distance between the first and second mobile proximity device, such as a Time Distance of Arrival (TDoA) method described in more detail below may be used.

In a number of embodiments, a mobile proximity device may be necessary for entrance to a controlled space, such as an office building or other premise. The mobile proximity device may be swiped, passed by, or positioned in appropriate proximity to a fixed proximity device. The fixed proximity device may be configured to sense and authenticate the mobile proximity device, and is constructed and arranged to enable access onto a particular controlled space and/or a particular zone of a controlled space by facilitating the disengagement of a lock, the opening of a door, or the removal of path obstructions upon authentication of the mobile proximity device in response to a proper presentation of the mobile proximity device. The fixed proximity device may require additional steps for authentication of a mobile proximity device for security or safety reasons. These additional steps may include items such as but not limited to weighing an object, verifying identity of a mobile proximity device wearer, e.g., an employee in an office building, by an additional modality such as by taking a picture of an object or individual for analysis, retrieving biometric data for an individual such as body temperature, and so forth. In a number of embodiments, a fixed proximity device may be strategically placed on a controlled premise and configured to read mobile proximity devices as well as to allow authenticated individuals and objects carrying mobile proximity devices onto the controlled premises or onto a particular zone of the controlled premises. The fixed proximity device may be battery powered or powered by an electrical grid. The fixed proximity device may comprise authentication capability hardware or software such as but not limited to a near-field communication card reader, a smart card reader, an RFID tag reader, a magnetic strip reader, a radio such as a Bluetooth radio, ultra-wideband technology, or a Wi-Fi transceiver. The fixed proximity device may be configured to identify each mobile proximity device upon authentication and receive or retrieve data from the mobile proximity device while reading it. The fixed proximity device may associate additional data provided by the fixed proximity device itself with anything retrieved or received from the mobile proximity device such as but not limited to current climate, attributes of authentication instance such as but not limited to, in the case of a near-field device, the distance of the mobile proximity device comprising the near-field device from the fixed proximity device at the time of authentication. The fixed proximity device may transmit the data received or retrieved from the mobile proximity device with any additional associated data to a central storage system such as but not limited to a data center or a cloud storage system. This stored data may be processed by an analytics algorithm to associate all collected data across all fixed proximity devices to produce analytical data based on a determination of where and when each mobile proximity device was authenticated. This determination data may be delivered by the analytics algorithm to an analytics portal where the determination data may be displayed in a visually intuitive manner.

A fixed proximity device according to the present disclosure is a device that is typically in a fixed location or stationary. The fixed proximity devices described herein may also be referred to as “port devices” in the plural and “port device” in the singular. Non-limiting examples of fixed proximity devices include stationary devices deployed at the entry or exit of a building, facility or controlled area (e.g., devices to trigger data upload, turn ranging on/off, grant access, or count heads); stationary devices deployed in an area for the purpose of local/temporary modification of alarm rules (e.g., in a medical examination room to silence alarm for duration of the medical care); stationary devices to facilitate device management (e.g., devices to trigger firmware update when devices are placed in a certain area); or devices to trigger data exchange when a mobile proximity device is in proximity to an access point with a strong signal. The fixed proximity devices may be physically identical to their mobile proximity device counterparts. The fixed proximity devices may assist communication by receiving and buffering data exchanges or by triggering exchange when mobile proximity devices are in proximity to an access point; or may alter or trigger a mobile proximity device's behavior based on location, for example, as identified in the above scenarios. The fixed proximity devices could also be used to determine range and location of the mobile proximity devices using, for example, ultra-wide band (UWB) two way ranging, RSSI (signal strength), or FTM feature available in wi-fi. The mobile proximity devices may recognize fixed proximity devices and an associated behavioral directive through direct communication, or by a pre-configured list of fixed or secondary proximity device addresses.

In a number of embodiments, secondary proximity devices may communicate or interact with one or more mobile proximity devices. Such secondary proximity devices may be capable of communicating with one another via radio or other means, connecting to and communicating over a Wi-Fi network, connecting to and communicating over an ultra-wideband network, connecting to a network via wire, and so forth. Each of these secondary proximity devices may be constructed and arranged to receive or retrieve data from a mobile proximity device, and may also be configured to exchange data with a mobile proximity device. The mobile proximity device may receive or collect data from the secondary proximity devices that may be used by the mobile proximity device to update its own profile. The secondary proximity devices may also be configured to update the data of the mobile proximity device. In some cases, the secondary proximity devices may collect data from the mobile proximity device for storage or transmission to an administration system, e.g., a central computing and/or storage system, for analysis and/or storage. The secondary proximity devices that do not have a connection to the administration system, e.g., the central storage and/or processing system, may in some cases communicate pertinent mobile proximity device data to other devices that have a connection the administration system.

In a number of embodiments, the proximity system according to the present disclosure may be configured to may gamify a configurable goal of the disclosed method by producing mobile proximity device wearer scores pertaining to the movements, actions, approximate contacts, durations of approximate contacts, or resulting probabilities of contributing to the spread of a contagion. These scores may be presented to the mobile proximity device wearer or other individuals to whom the score may be relevant or informative. Such scores may be generated by the mobile proximity devices themselves and updated whenever the mobile proximity devices interact or communicate with another mobile proximity device or a fixed proximity device. Scores may also be calculated at the administration system, e.g., a central computing and/or storage system, and communicated back to the mobile proximity devices or to an individual or entity associated with a particular mobile proximity device via a web-based interface, a mobile application, software for a personal computer, e-mail, printout, or any means known to convey information from the administration system to an individual or entity.

In a number of embodiments, secondary proximity devices constructed and arranged to communicate with one or more mobile proximity devices may include, but are not limited to, a connected light or light fixture, a connected plug for an electrical outlet, or a standalone connected device that may be strategically placed and powered by any number of power sources such as but not limited to renewable energy, battery, wire, or ethernet. Any such secondary proximity devices may be configured to exchange data with or update the data of a mobile proximity device. As a non-limiting example, connected lights or light fixtures may be constructed and arranged to transmit data resulting from such communications to the administration system for organization and analysis. Such lights or light fixtures may also be configured to relay communications between one another, to other devices such as but not limited to a fixed proximity device.

In a number of embodiments, a secondary proximity device configured to communicate with a mobile proximity device may remain in a generally idle state, and periodically transmit proximity event data using a first radio according to a first wireless communication protocol. This periodic transmission of proximity event data may be an attempt by the secondary proximity device to locate and engage in wireless communications with a mobile proximity device. The mobile proximity device may use a first onboard radio module to respond to the chirp according to a first wireless communication protocol. Upon receiving the response, the secondary proximity device may commence communications with the mobile proximity device according to a second wireless communications protocol by using a second radio. The mobile proximity device may then also engage in communications with the secondary proximity device according to the second wireless protocol by using a second onboard radio module. As a non-limiting example, the first radio may be a Bluetooth radio and the first wireless communication protocol may be a Bluetooth communications protocol, while the second radio may be an ultra-wideband radio and the second wireless communication protocol may be an ultra-wideband communications protocol. It is noted that the transmissions (or communication) between a secondary proximity device and a mobile proximity device may be a one-way exchange or a two-way exchange.

In a number of embodiments, secondary proximity devices may be constructed and arranged to triangulate or trilaterate the position of a mobile proximity device by known triangulation or trilateration methods utilizing radio communications with the goal of indoor localization and movement tracking. This localization may be correlated to a global position to produce a global positioning and tracking effect.

In a number of embodiments, the methods and products described may be configurable to avoid the spread of or exposure to toxic chemicals, radiation, parasites, pests, etc. Such configurations may be achieved via an administration system, e.g., a central processing and/or storage system, such as but not limited to a local server, a data center, a cloud computing or cloud storage service, and so forth. As a non-limiting example, if a radiation emitting object carrying a mobile proximity device is moved through a relatively small corridor while an unwitting mobile proximity device wearer approaches the radiation emitting object, the mobile proximity device of the wearer may provide haptic or audio feedback to the wearer of the mobile proximity device to indicate that the probability of becoming irradiated by the radiation emitting object has increased. In such a case, the data exchanged between the mobile proximity device of the radiation emitting object and the mobile proximity device of the wearer may be configured to take into account the relative risks involved. For example, the mobile proximity device of the radiation emitting object may be configured to simply make note of the proximity of the mobile proximity device of the wearer while the mobile proximity device of the wearer may be configured to receive a radiation metric from the mobile proximity device and determine the likelihood or risk of dangerous exposure to radiation by the mobile proximity device wearer based at least upon the wearer's distance from the radiation emitting object, as well as to provide a haptic or audio warning indicative of the likelihood or risk of dangerous exposure.

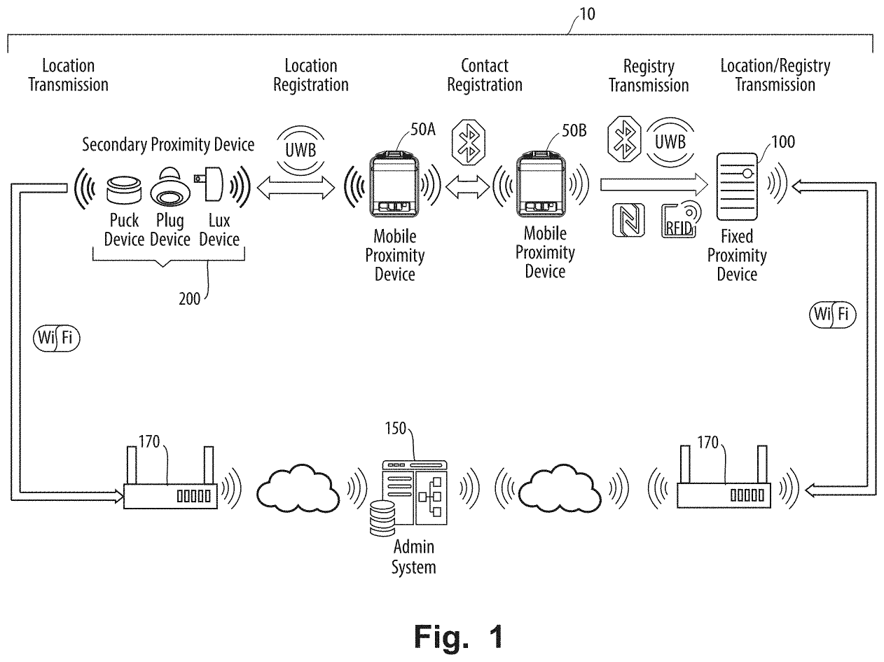

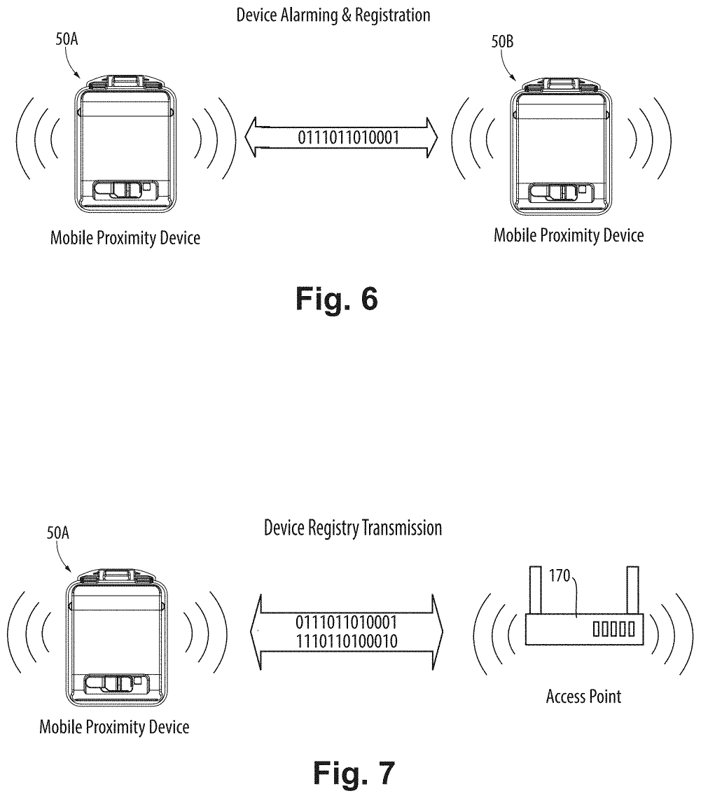

Referring now to the figures, FIG. 1 depicts an exemplary schematic representation of a proximity system 10 according to the present disclosure having one or more mobile proximity devices 50, and one or more fixed proximity devices 100. The proximity system 10 according to the present disclosure may also include one or more administration systems 150 and/or one or more secondary proximity devices 200. In the embodiments described herein there may be multiple mobile proximity devices 50 and for ease of description and clarity each of the multiple mobile proximity devices may be referenced with an alphanumeric identifier. For example, a first mobile proximity device may be referenced as first mobile proximity device 50A and a second mobile proximity device may be referenced as second mobile proximity device 50B. In the embodiment of FIG. 1, a first mobile proximity device 50A may be worn by a first wearer and a second mobile proximity device 50B may be worn by a second wearer. In this exemplary embodiment, the first and second mobile proximity devices 50A and 50B are multi-function mobile proximity devices that may perform a first function of security authentication and a second function of proximity event detection. In this embodiment, each mobile proximity device 50A and 50B may store and update information or data about itself using an onboard controller and memory, described in more detail below, as the wearer moves about a controlled space, e.g., a building or premise. Such information or data includes, for example, security authentic information, proximity event data, and internal operations data (e.g., operation of ranging function, and battery charge state), and user interaction data (e.g., button presses, battery charging). Each mobile proximity device 50 may also be configured to have this information or data updated by other proximity devices, e.g., mobile proximity devices 50 and/or fixed proximity devices 100. Thus, each mobile proximity device 50 may be constructed and arranged to communicate and exchange data with other proximity devices, e.g., mobile proximity devices 50 and/or fixed proximity devices 100, using for example a Bluetooth radio. To illustrate, the first mobile proximity device 50A may be configured so that when the second mobile proximity device 50B enters a predefined communication range of the first mobile proximity device 50A, i.e., is in close proximity to the first mobile proximity device, the first mobile proximity device 50A may be induced by its own configuration or by the second mobile proximity device 50B to update information or data stored in the first mobile proximity device 50A in a manner that indicates that the first and second mobile proximity devices 50A and 50B came into close proximity with one another. Similarly, the second mobile proximity device 50B may be configured so that when the first mobile proximity device 50A enters a predefined communication range of the second mobile proximity device 50B, i.e., is in close proximity to the second mobile proximity device, the second mobile proximity device 50B may be induced by its own configuration or by the first mobile proximity device 50A to update information or data stored in the second mobile proximity device 50B in a manner that indicates that the first and second mobile proximity devices 50A and 50B came into close proximity with one another, as seen in FIG. 6. To clarify, contacting devices 50A and 50B may exchange address data as part of the ranging operation, as seen in FIG. 5, or a separate operation as seen in FIG. 6. The predefined communication range may be, for example, between about seven inches and about ten feet. Further, the mobile proximity devices 50 may exchange the information or data pertaining to the circumstances of their close proximity encounter. In addition, each mobile proximity device 50 may also upload its information or data to a fixed proximity device 100.

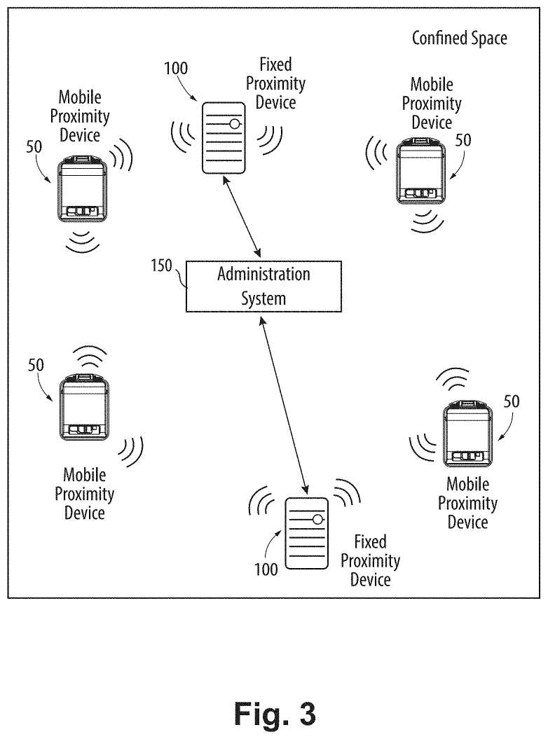

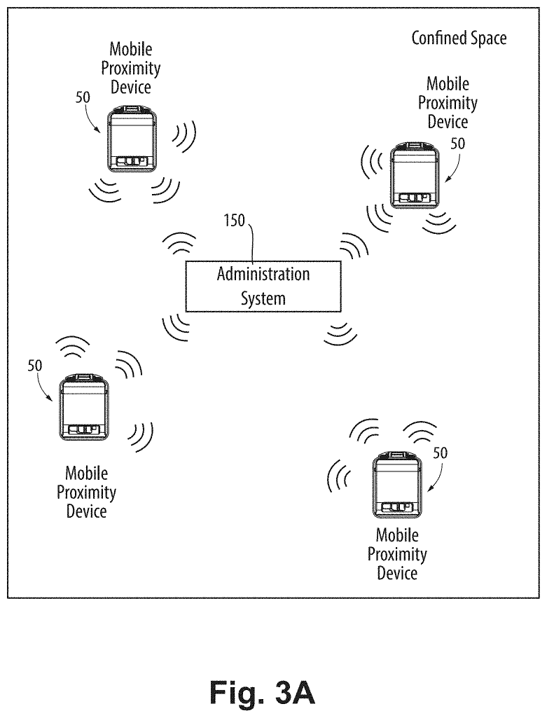

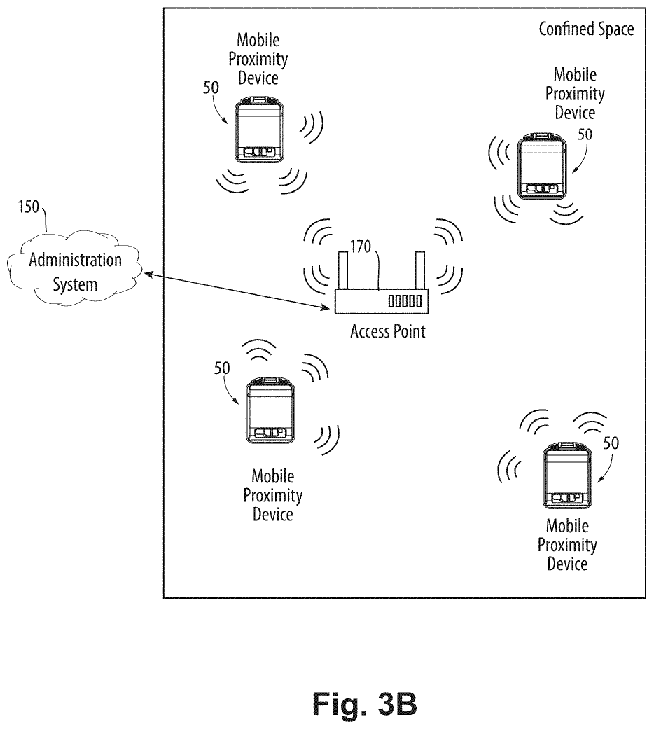

Continuing to refer to FIG. 1, in this exemplary embodiment, the fixed proximity device 100 is a multi-function fixed proximity device that may perform a first function associated with security authentication and a second function associated with proximity event detection. The fixed proximity device 100 according to the present disclosure may be constructed and arranged to read at least some of the data stored on each mobile proximity device 50 in response to the mobile proximity device 50 entering the predefined communication range of the fixed proximity device 100. The fixed proximity device 100 may be configured to grant the wearer of a mobile proximity device 50 entry to a particular zone of a controlled premise upon authentication of the mobile proximity device 50. The fixed proximity device 100 may also be configured to read information or data, e.g., proximity event data, from one or more mobile proximity devices 50 and to transmit such information or data read from the one or more mobile proximity devices 50 to the administration system 150, e.g., the central computing and/or storage system, seen in FIG. 3. As an illustration, the fixed proximity device 100 may be constructed and arranged to enable the wearer of the first mobile proximity device 50A access into a particular zone of a controlled premises by, for example, facilitating the disengagement of a lock, facilitating the opening of a door or facilitating the removal of path obstructions upon authentication of the first mobile proximity device 50A. Authentication of the first mobile proximity device 50A by the fixed proximity device 100 may be achieved using, for example, RFID, smartcard, ultrawide band, or near-field communication protocols. Additionally, the fixed proximity devices 100 may be configured to trigger a recording event at the administration system 150, e.g., the central computing and storage system, that may indicate that the first mobile proximity device 50A should thereafter be tracked by fixed proximity device s 100 or secondary proximity devices 200 on the controlled premises. Such recording event may be processed in real time or buffered by a fixed proximity device 100 for later transmission to the administration system 150.

In another exemplary embodiment shown in FIG. 3A, the mobile proximity devices 50 may be constructed and arranged to communicate directly with the administration system 150, e.g., a central computing and/or storage system, using for example, a built-in Wi-Fi radio. In this configuration, once authenticated by the administration system 150, a wearer of a mobile proximity device 50 may be permitted access into one or more zones of a controlled premises. The administration system 150 may authenticate the mobile proximity device 50 by a look-up table that designates what zones within a controller premise the particular wearer may be permitted access. The administration system 150 may facilitate access to a particular zone by, for example, the disengagement or release of a lock, the opening of a door, or the removal of path obstructions. Additionally, the administration system 150 may also track the movement of the wearer of a mobile proximity device 50 within the controlled premise.

After a mobile proximity device 50 is authenticated and allowed onto the premises by, for example, a fixed proximity device 100, other secondary proximity devices 200 located within the controlled premises may be configured to read data from or update data on the mobile proximity devices 50 and similarly transmit pertinent data from this interaction to the administration system 150. Particularly, the secondary proximity devices 200 may transmit data pertaining to their own location and their own device type to the administration system 150 along with pertinent data read from the mobile proximity devices 50. Non-limiting examples of secondary proximity devices 200 include devices embedded in lighting fixtures.

The administrative system 150 is configured to analyze and store data transmitted to it by fixed proximity devices 100 and secondary proximity devices 200 on the premise and may correlate the data according to a predefined process (or algorithm) configured to produce useful tracking data about wearers of mobile proximity devices 50 that enter or traverse the controlled premises. Visualization software, such as Microsoft Power BI, may be used to present such data intuitively on a capable presentation device, such as a Windows based personal computer should an assessment of the movements and actions of the wearers of mobile proximity devices be initiated. In a non-limiting example, the administrative system 150 may maintain data within a database such as a SQL database. The Microsoft Power BI application is linked to the database and can access data and generate reports and presentation graphics on demand. The administrative system 150 may also maintain data in other formats, such as numerous small files representing instances of uploaded data from each mobile proximity device 50.

In another exemplary embodiment shown in FIG. 3B, the mobile proximity devices 50 may be constructed and arranged to communicate directly with an access point 170 that then communicates with the administration system 150, e.g., a central computing and/or storage system, having for example, a Microsoft Azure server, or a web server (e.g., an HTTP or HTTPS server) that may be hosted locally or remotely (e.g., by a third party web hosting service). In this configuration, all communication between the one or more mobility proximity devices 50 and the administration system 150 is via the access point 170. In this configuration, when a mobile proximity device 50 comes within communication range of the access point 170, the mobile proximity device 50 provides, for example, location data, wearer data and a mobile proximity device type and identification (ID) data to the administration system 150 via the access point 170 for authentication. Once authenticated by the administration system 150, a wearer of a mobile proximity device 50 may be permitted access into one or more zones of a controlled premises. The administration system 150 may authenticate the mobile proximity device 50 by a look-up table that designates what zones within a controller premise the particular wearer may be permitted access. The administration system 150 may facilitate access to a particular zone by, for example, the disengagement or release of a lock, the opening of a door, or the removal of path obstructions upon. Additionally, the administration system 150 may via the access point 170 also track the movement of the wearer of a mobile proximity device 50 within the controlled premise. A non-limiting example of an access point 170 is a Wi-Fi router. The administrative system 150 is also configured to analyze and store data, such as proximity event data, transmitted to it by the mobile proximity devices 50 in the premise and may correlate the data according to a predefined process (or algorithm) configured to produce useful tracking data about wearers of mobile proximity devices 50 that enter or traverse the controlled premises. Visualization software, such as Microsoft Power BI, may be used to present such data intuitively on a capable presentation device, such as a Windows based personal computer (PC) should an assessment of the movements and actions of the wearers of mobile proximity devices be initiated.

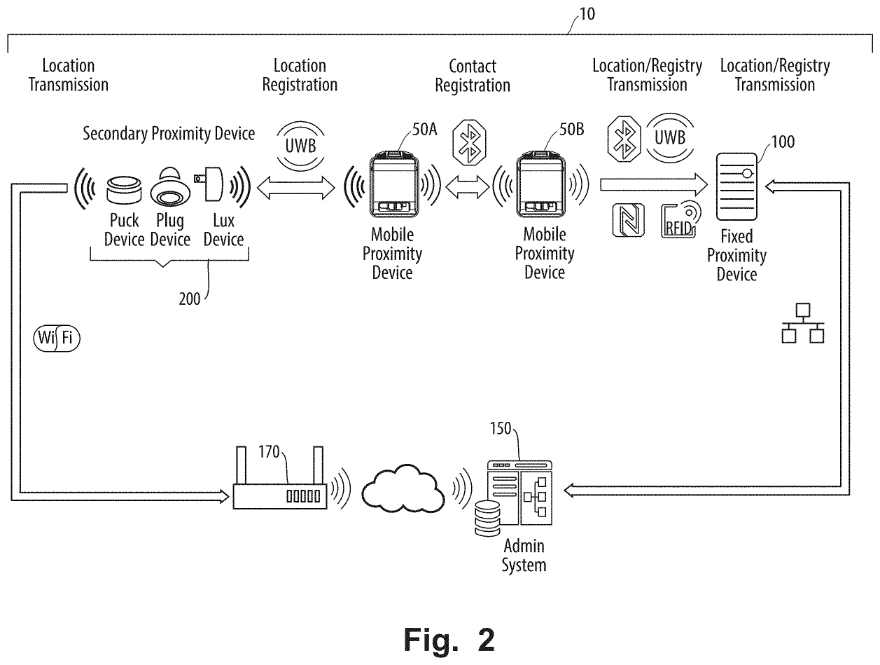

Referring now to FIG. 2, the first and second mobile proximity devices 50A and 50B and the fixed proximity device 100 may be configured similarly to that described with regard to FIG. 1, however the mobile proximity devices 50 within the controlled premises may not be constructed and arranged to communicate with the administration system 150 directly. Instead, the mobile proximity devices 50 in the controlled premises may be constructed and arranged to update a single mobile proximity device 50, e.g., the first mobile proximity device 50A, with location data and a device type and device ID data for each mobile proximity device 50 that the first mobile proximity device 50 enters the predetermined proximity of while moving through the controlled premise. Upon leaving the controlled premises, a fixed proximity device 100 may be constructed and arranged to read pertinent data, as well as the additional location data and device type and device ID for each mobile proximity device 50 that the first mobile proximity device 50 entered the proximity of on the controlled premises. In such an embodiment, the fixed proximity device 100 may then communicate to the administrative system 150 all data read from the first mobile proximity device 50A when, for example, the first mobile proximity device leaves the controlled premises. Additionally, the mobile proximity devices 50 on the controlled premise may be constructed and arranged to communicate only with one another or with a secondary proximity device 200 that is capable of uploading the intra-communications of the mobile proximity devices 50 to the administration system, similar to that shown in FIG. 1.

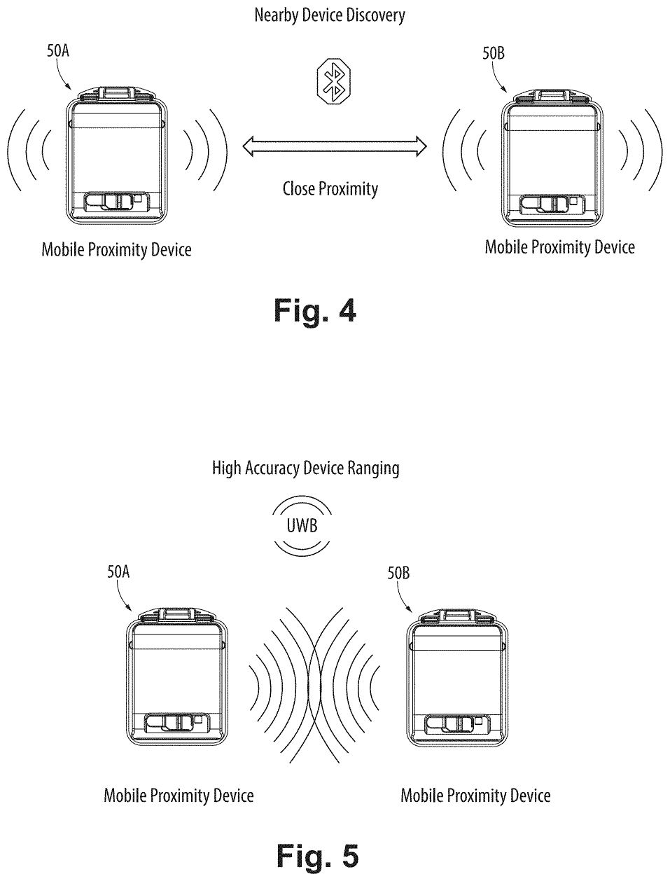

Referring now to FIGS. 4-7, another exemplary embodiment of a system according to the present disclosure is shown. In this exemplary embodiment of the system 10, two or more mobile proximity devices 50 are configured to communicate with each other when the mobile proximity devices are within communication range of each other, to calculate a distance between the mobile proximity devices 50, to compare the calculated distance to a predefined distance, and to provide an alarm or warning when the mobile proximity devices are at or within the predefined distance. It is noted, that the communication range is a distance at which the mobile proximity devices 50 may electronically communicate with each other using, for example, Bluetooth technology. The communication range may be equal to or greater than the predefined proximity distance, and depends upon the communication method employed. As a non-limiting example, the communication range using Bluetooth technology may be between about 100 feet and about 500 feet. The predefined proximity distance may be, for example, a suggested or required distance where the two mobile proximity devices are to remain apart. This predefined proximity distance may also be referred to herein as being in close proximity. As a non-limiting example, the predefined proximity distance may be in the range of about one and about ten feet. Preferably, the predefined proximity distance is about six feet.

In the exemplary embodiment of FIG. 4, a first mobile proximity device 50A detects when a second mobile proximity device 50B is within the communication range of the first mobile proximity device 50A, and the second mobile proximity device 50B detects when the first mobile proximity device 50A is within the communication range of the second mobile proximity device 50B. When the first mobile proximity device 50A is within the communication range of the second mobile proximity device 50B and the second mobile proximity device 50B is within the communication range of the first mobile proximity device 50A, the two mobile proximity devices 50A and 50B can then exchange information between them so that each mobile proximity device 50A and 50B can, for example, calculate at least a close approximation of the distance between them. This ranging operation, which is illustrated in FIG. 5, may depend on contingent conditions, such as signal strength (RSSI). When the first mobile proximity device 50A determines that the distance between itself and the second mobile proximity device 50B is within the predefined proximity distance, the first mobile proximity device 50A can activate an alarm or warning to the wearer indicating the first mobile proximity device 50A is at or within the predefined proximity distance of the second mobile proximity device 50B. Similarly, when the second mobile proximity device 50B determines that the distance between itself and the first mobile proximity device 50A is within the predefined proximity distance, the second mobile proximity device 50B can activate an alarm or warning to the wearer indicating the second mobile proximity device 50B is at or within the predefined proximity distance of the first mobile proximity device 50A. The distance calculations may also be stored in memory in both the first and second mobile proximity devices.

As described above, to calculate the distance between mobile proximity devices, e.g., the first and second mobile proximity device 50A and 50B, the amount of time for a radio signal to travel from the first mobile proximity device 50A to the second mobile proximity device 50B may be used. Calculating distance based on a time it takes a transmitted signal to be received is known as Time of Flight (ToF) or Two-Way Ranging (TWR). For ease of description, the present disclosure refers to calculating the distance between a first mobile proximity device 50A and the second mobile proximity device 50B based on a time it takes a transmitted signal from one mobile proximity device to be received by the other mobile proximity device as Two-Way Ranging (TWR). Since radio frequency energy may propagate at the constant speed of light, TWR may directly correlate to the distance between the first and second mobile proximity devices 50A and 50B. More specifically, by knowing the time at which the first mobile proximity device 50A sends a radio signal and the time that the radio signal arrives at the second mobile proximity device 50B, the difference in time between the transmission and reception of the radio signal multiplied by the speed of light determines the distance between the first mobile proximity device 50A and the second mobile proximity device 50B. Similarly, by knowing the time at which the second mobile proximity device 50B sends a radio signal and the time that the radio signal arrives at the first mobile proximity device 50A, the difference in time between the transmission and reception of the radio signal multiplied by the speed of light determines the distance between the second mobile proximity device 50B and the first mobile proximity device 50A. Alternatively, the mobile proximity device 50A may send a radio signal to mobile proximity device 50B which then responds back to mobile proximity device 50A. Mobile proximity device 50A is thus in a position to determine the round trip time of the radio signal sent by the mobile proximity device 50A; and deducting latencies, calculate the distance between the mobile proximity devices 50A and 50B. Thus, in this exemplary configuration, a coordinated clock or time base between mobile proximity devices 50A and 50B would not be necessary. Multiple other permutations of TWR techniques are also contemplated by the present disclosure.

With TWR, the first mobile proximity device 50A may store the local onboard time of the first mobile proximity device 50A at which the first mobile proximity device transmits a start signal (or packet) request to be received by one or more mobile proximity devices 50, which in this exemplary embodiment is the second mobile proximity device 50B. The receiving second mobile proximity device 50B stores both the local onboard time of the second mobile proximity device 50B when it receives the start signal from the first mobile proximity device 50A and also the time the second mobile proximity device 50B transmits a start signal that is received by the first mobile proximity device. The second mobile proximity device 50B may then send an additional packet to the first mobile proximity device 50A that contains the local onboard receiving and transmitting times stored by the second mobile proximity device 50B. The first mobile proximity device 50A may thus use this information along with its local onboard timestamp for transmission of the start signal (or packet) to calculate the distance between the first mobile proximity device 50A and the second mobile proximity device 50B. Similarly, after the first mobile proximity device 50A receives a start signal from the second mobile proximity device 50B, the first mobile proximity device may then send an additional packet to the second mobile proximity device 50B that contains the local onboard receiving and transmitting times stored by the first mobile proximity device 50A. The second mobile proximity device 50B may thus use this information along with its local onboard timestamp for transmission of the start signal (or packet) to calculate the distance between the second mobile proximity device 50B and the first mobile proximity device 50A. The TWR method may require multiple signals (or packets) to be passed back and forth between every pair of mobile proximity devices 50 that come into the communication distance of one another in order to calculate the distance between mobile proximity devices 50. If a third mobile proximity device is introduced into the communication distance, start and additional signals (or packets) may be passed between the first and second mobile proximity devices, the first and third mobile proximity devices, and between the second and third mobile proximity devices. As the number of mobile proximity devices increases, the number of start and additional signals (or packets) exchanged may need to increase accordingly.

Referring now to FIG. 7, which illustrates the mobile proximity device 50 exchanging data with the administrative system 150 by way of an Internet access point 170 (e.g., a Wi-Fi router). The mobile proximity device 50 is programmed to store (or log) data including proximity event data, and periodically upload such data to the administrative system 150. For example, the mobile proximity device 50 my upload data, e.g., proximity event data, once per day. The uploads from the mobile proximity devices 50 to administrative system 150 may be further scheduled during specific time periods to best ensure that the user is present on site at the scheduled upload time. Furthermore, a secondary proximity device may be used to prompt the upload when the user and mobile proximity device are proximate to the access point 170 with potential for a strong connection. The mobile proximity device 50 initiates the exchange by first connecting to the access point 170 via Wi-Fi using the stored service set identifier (SSID) and password. If the connection is successful, data or the contents of the mobile proximity device's logs are uploaded to the administrative system 150 via the Internet or local network as appropriate. The administrative system 150 sends a reply packet to the mobile proximity device 50 in acknowledgement, which may include a time reset and/or other commands as configured by the system administrators. Such commands may include, for example, schedule changes defining when to activate the ultrawide band (UWB) radio for ranging. Upon successful acknowledgement, the mobile proximity device 50 may also purge its logged data. The process described herein is one example, other sequences are contemplated by the present disclosure. Lastly, the mobile proximity device 50 disconnects from the access point 170. If the data exchange process is not successful, the mobile proximity device 50 may retry after a predetermined time delay, e.g., 5 minutes.

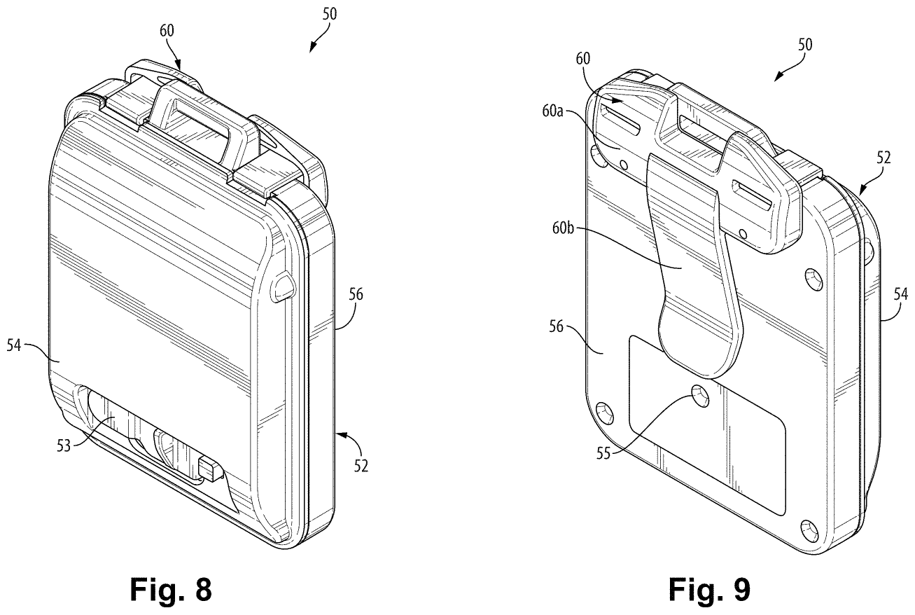

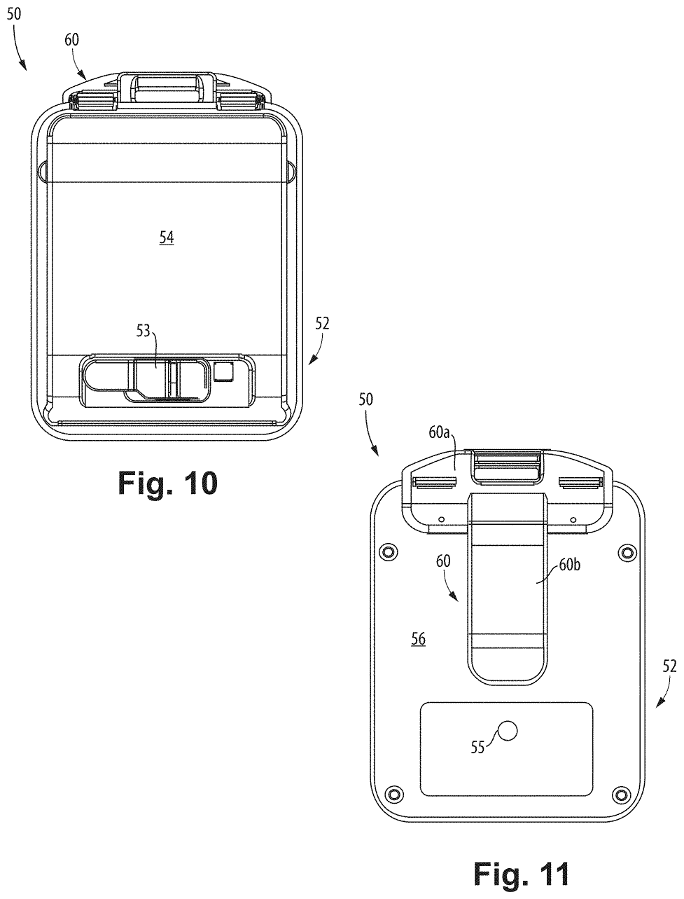

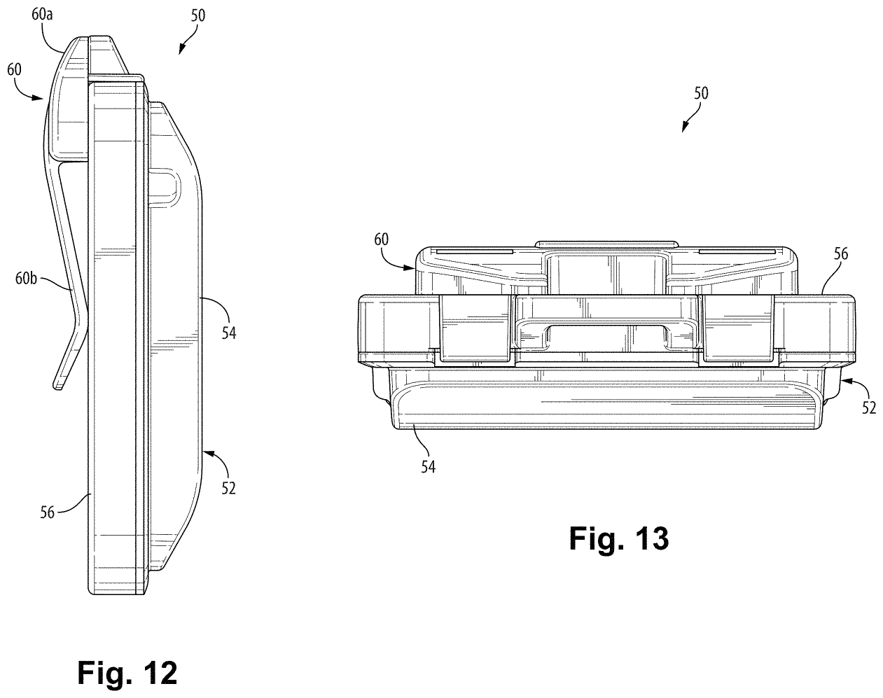

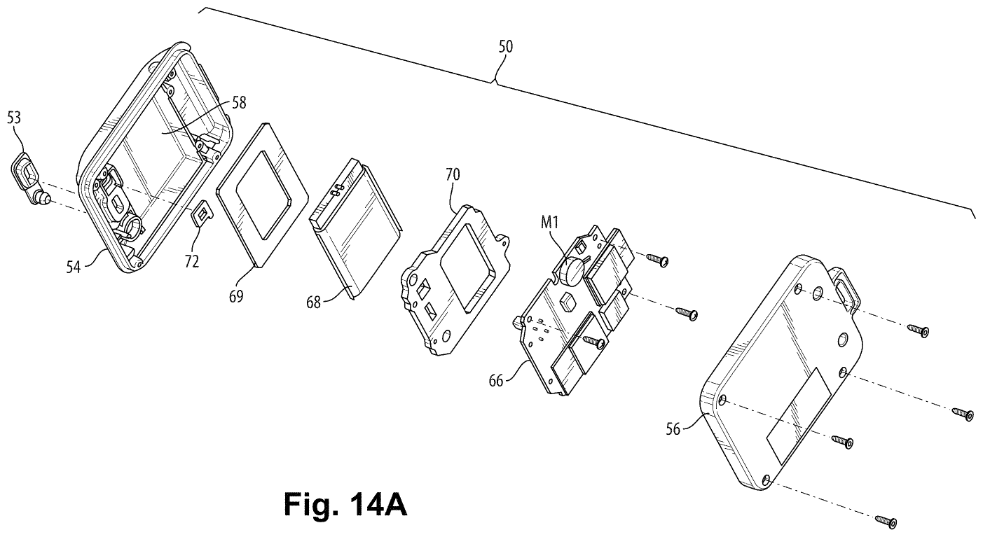

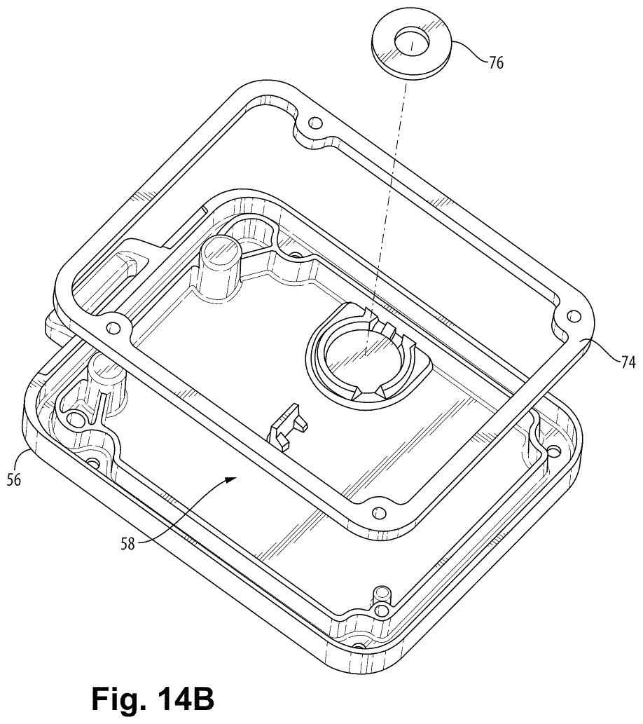

Referring now to FIGS. 8-14A and 14B, an exemplary embodiment of a mobile proximity device according to the present disclosure is shown. In this exemplary embodiment, the mobile proximity device 50 includes a housing or casing 52 having a front housing portion 54 and a rear housing portion 56 that may be permanently affixed to the front housing portion 54 or releasably secured to the front housing portion 54 using, for example, fasteners such as screws, or a snap-fit connection. Within the inside of the front housing portion 54 and/or the inside of the rear housing portion 56 is one or more cavities 58, seen in FIG. 14, used to receive the internal components of the mobile proximity device 50. Preferably, the housing 52 is constructed of a lightweight, rigid material. In an exemplary embodiment, the housing 52 may be constructed of a polymer material that may be translucent. In another exemplary embodiment, the housing 52 may be constructed of a polymer material that may be translucent and mixed with antimicrobial additives to form an antimicrobial plastic. An antimicrobial plastic is a synthetic polymer material containing an integrated antimicrobial additive ingredient which makes the polymer material effective against microbial growth. Non-limiting examples of such polymer materials include injection molded or extruded thermoplastic polymers. Non-limiting examples of such polymer materials include Acrylonitrile Butadiene Styrene (ABS), Polypropylene (PP), Polystyrene (PS), Polyethylene (PE/LDPE), Polyvinyl chloride (PVC) and Polycarbonate (PC). Non-limiting examples of antimicrobial additives include non-metallic based antimicrobial additives. The housing 52 may also include a clip member 60 attached to or monolithically formed into the rear housing portion 54 and used to releasably attach the mobile proximity device 50 to, for example, a belt of a wearer of the mobile proximity device 50. In the exemplary embodiment shown, the clip member 60 includes a mounting bracket 60a and a clip 60b.

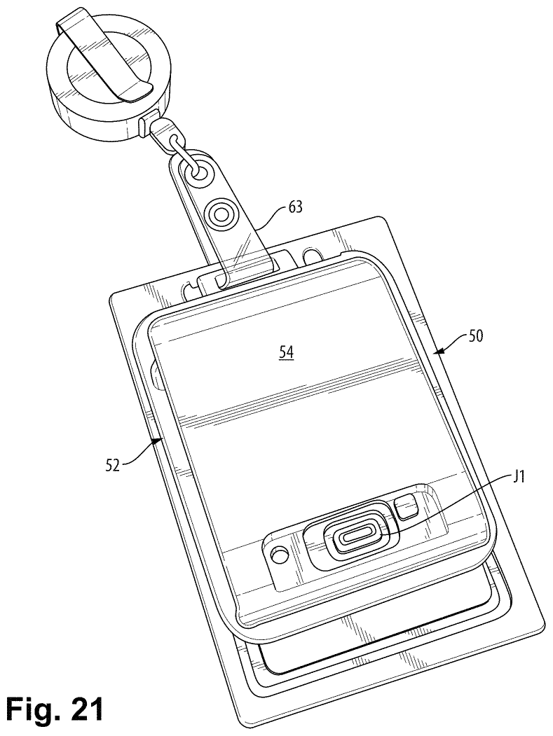

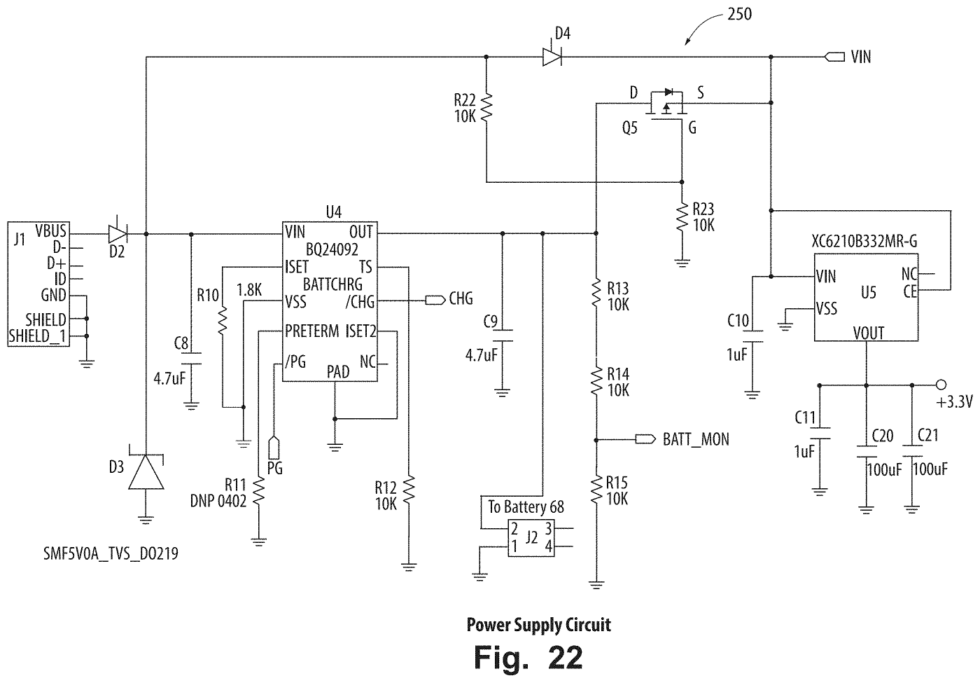

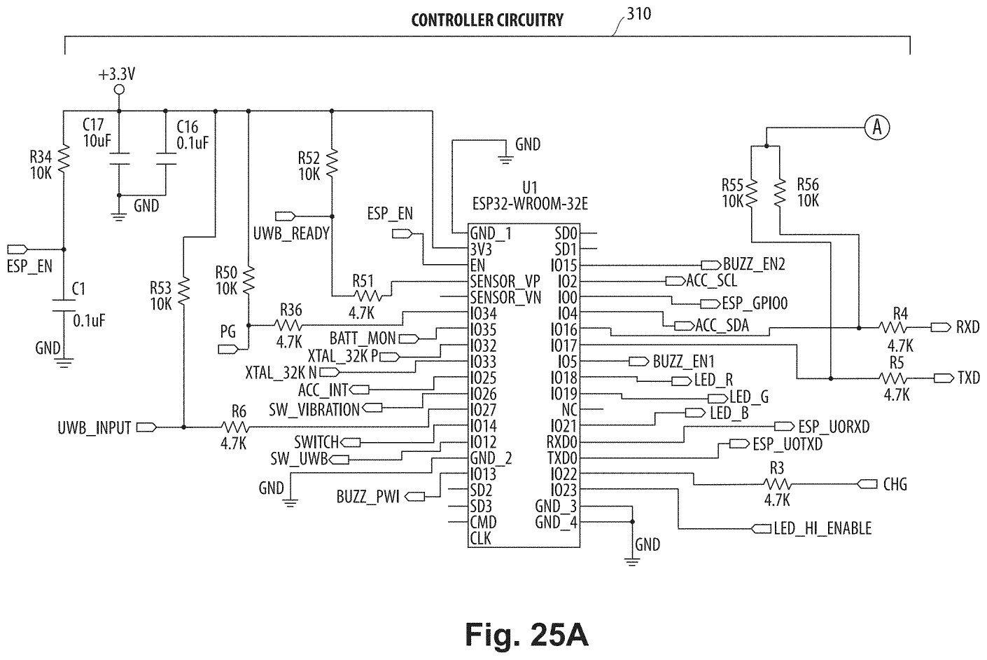

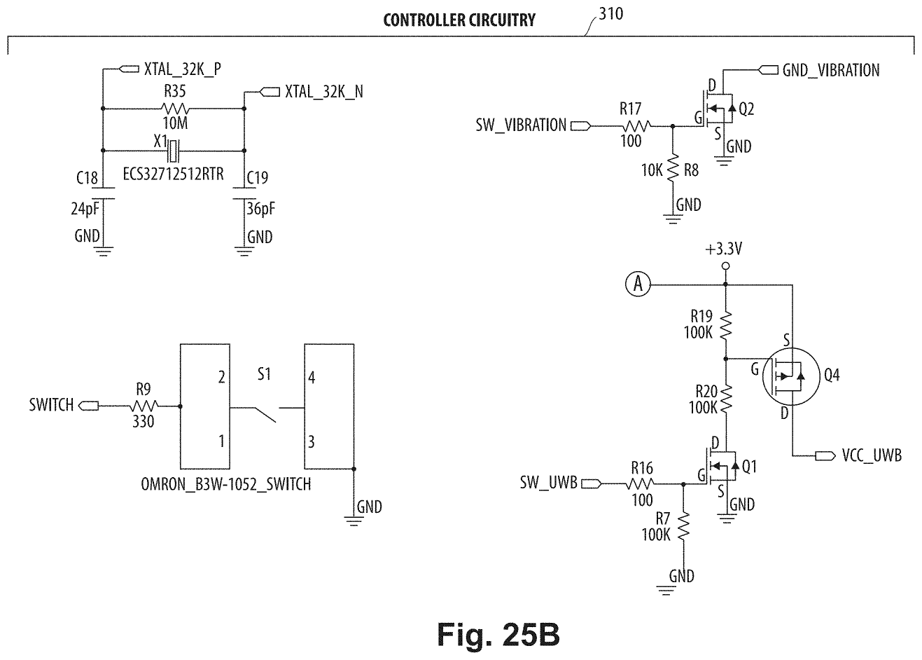

The housing 52 may be sealed using one or more seal members, for example, internal seal member 70, switch seal member 72, and housing seal member 74, as seen in FIGS. 14A and 14B. The one or more seal members may be gaskets such as elastomeric, rubber or foam gaskets that limit and possibly prevent moisture or water (rain, laundry cycles, etc.) from entering the housing 52. While the charging connector J1, seen in FIGS. 21 and 22, and the pushbutton switch S1, seen in FIGS. 21 and 25, are exposed on the exterior of the front portion 54 of the housing 52, they are mechanically protected from environmental conditions so that moisture does not penetrate further into the housing 52 using, for example, the switch seal member 72, and internal seal member 70, and electrically protected so that a short does not affect other circuitry within the housing 52. In addition, the housing 52 may also include a rubber cover 53, seen in FIG. 14A, for covering the charging connector J1.

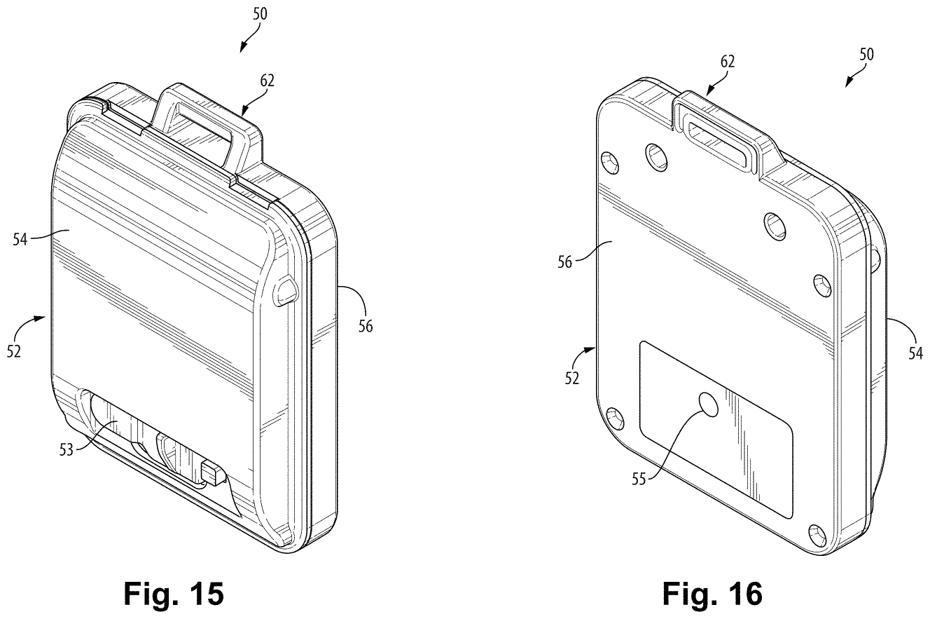

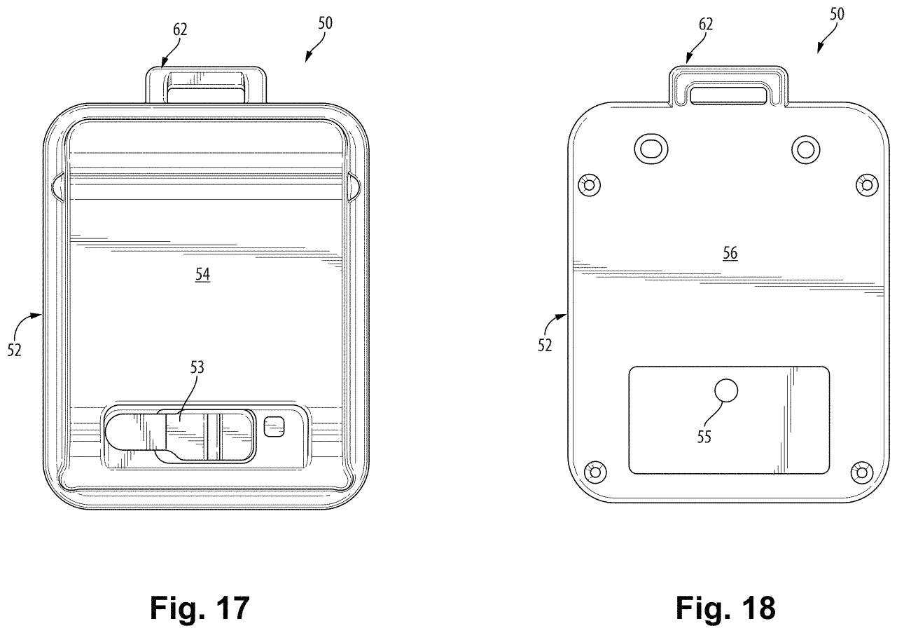

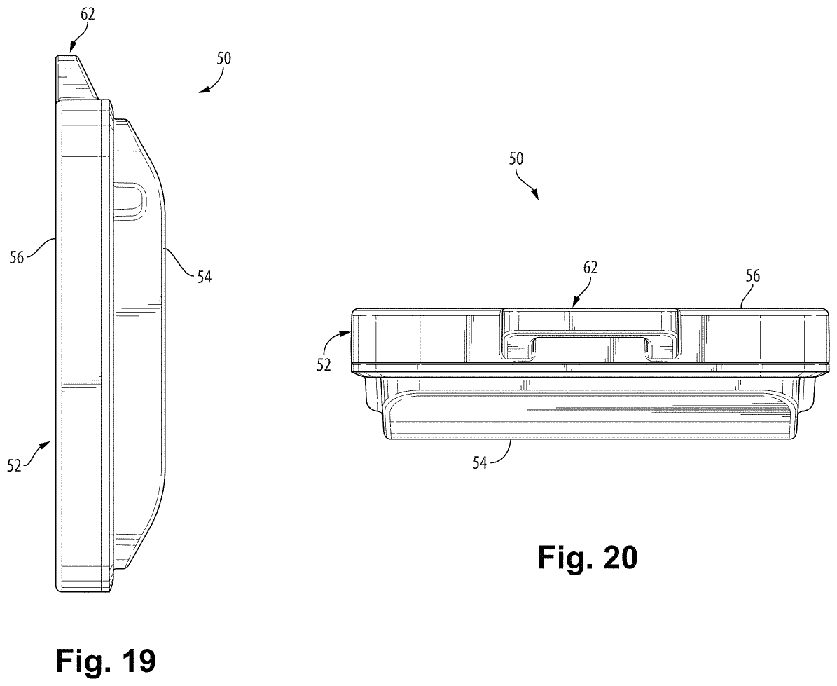

Another exemplary embodiment of the housing 52 is shown in FIGS. 15-21. In this exemplary embodiment, the housing 52 is substantially the same as the housing described above with reference to FIGS. 8-14B, except that the clip member 60 is replaced with a strap bracket 62 that is configured and dimensioned to receive a strap or lanyard 63, seen in FIG. 21. It is noted that the strap bracket 62 may also be included in the embodiment with the clip member 60. The strap bracket 62 may be attached to the rear portion 56 of the housing 52 or the strap bracket 62 may be monolithically formed into the rear portion 56 of the housing 52. Referring to FIG. 21, the strap 63 may be similar in dimensions as a conventional ID badge strap so that the mobile proximity device 50 can be releasably attached to an ID badge strap.

As shown in FIGS. 14A and 14B, a battery 68 can be fitted within one of the cavities 58 within the front housing portion 54 or the rear housing portion 56 of the housing 52 and provides electrical power to the mobile proximity device 50. A battery cushion 69 may be positioned between the battery 68 and the front portion 54 or the rear portion 56 of the housing 52. The battery 68 may any type of battery, including a rechargeable battery, such as a Lithium Polymer battery with a nominal voltage of about 3.7 volts. However, any battery 68 may be used to provide internal electrical power to the mobile proximity device 50. The battery 68 of the mobile proximity device 50 may be constructed and arranged to be recharged by a power source constructed and arranged to generate charge from a renewable source, such as but not limited to a gyroscopic generator, a piezoelectric generator, a solar panel, a wind-driven generator, a thermo-electric generator and so on. In other embodiments, the source of power for the mobile proximity device 50 may be configured to generate power as a result of movement of the housing 52, or biology or biological byproducts, such as but not limited to body heat of the wearer of the mobile proximity device 50. Any power sources for the mobile proximity device 50 may also be constructed and arranged to deliver power directly to any component powered by the battery 68 of the mobile proximity device 50. As described in more detail below, the mobile proximity device 50 may also be configured to sleep or enter a power saving state during certain times, in certain areas, or when the mobile proximity device detects that it is sitting idle for a period of time.

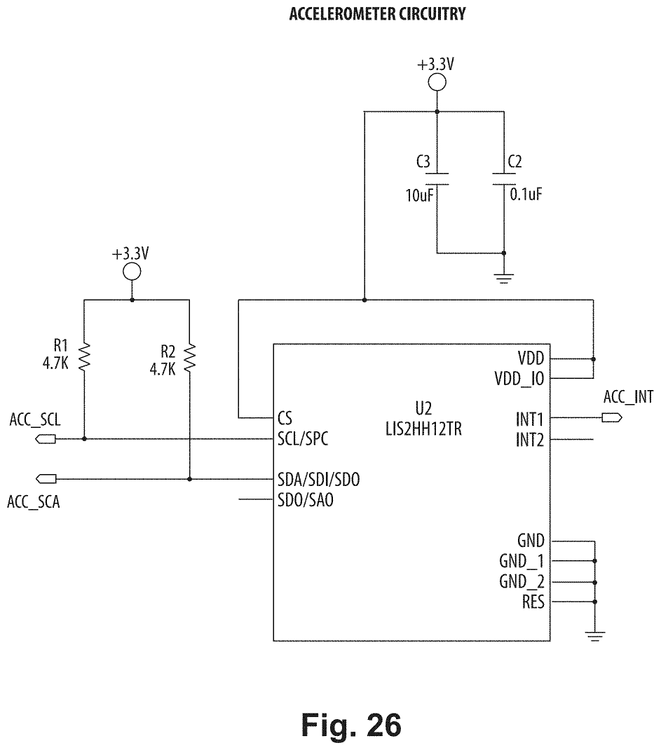

Referring now to FIGS. 22-28, internal components and circuits of the mobile proximity device 50 are shown. Internal circuitry of the mobile proximity device 50 includes power supply circuitry 250, UWB detector circuitry 270, indicator generator circuitry 290, and controller circuitry 310. The internal circuitry of the mobile proximity device 50 may also include accelerator circuitry 320 that is controlled by the controller circuitry 310. The power supply circuitry 250, shown in FIG. 22, includes a battery charging circuit U4 used to charge the battery 68 and a voltage regulator network U5 used to regulate the voltage supplied to the internal circuitry of the mobile proximity device 50. In the exemplary embodiments of the mobile proximity device 50 described herein, the battery 68 is a rechargeable battery that provides power to the internal components of the mobile proximity devices 50 via micro-connector J2. The power supply circuit 250 includes a micro-USB port J1 positioned on a printed circuit board 66 in the housing 52 and electrically connected to the battery charging circuitry U4 for recharging the battery 68.

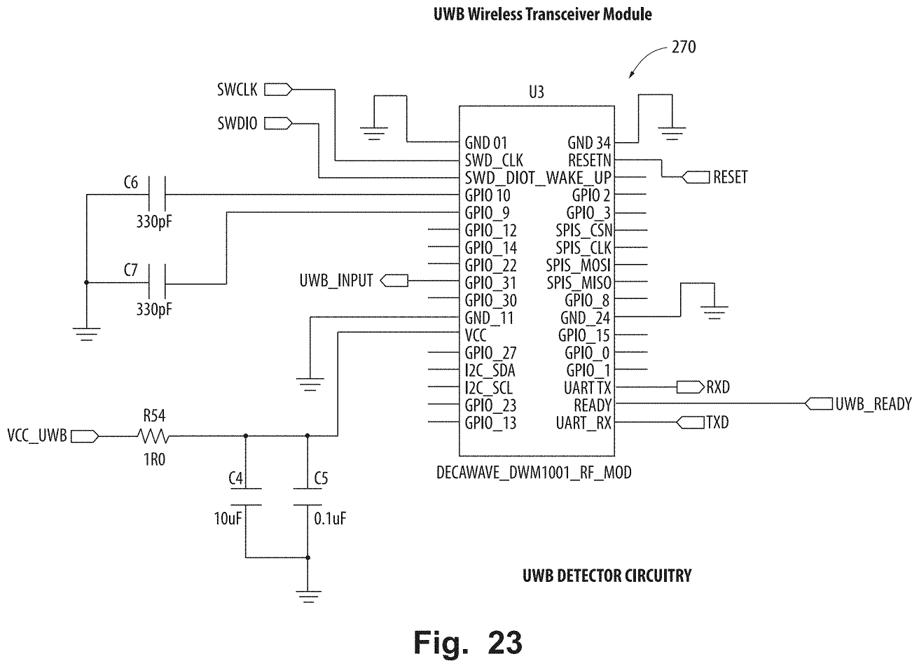

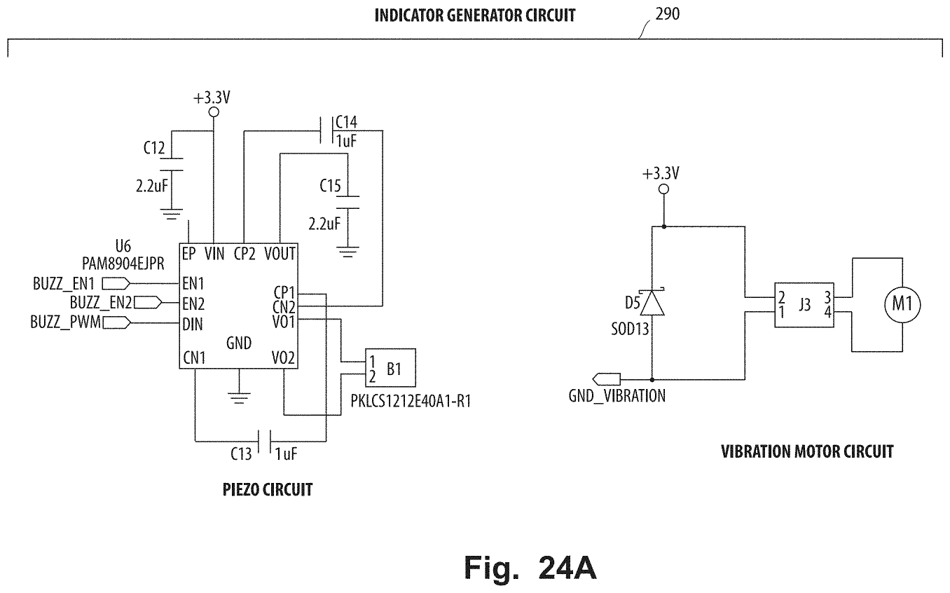

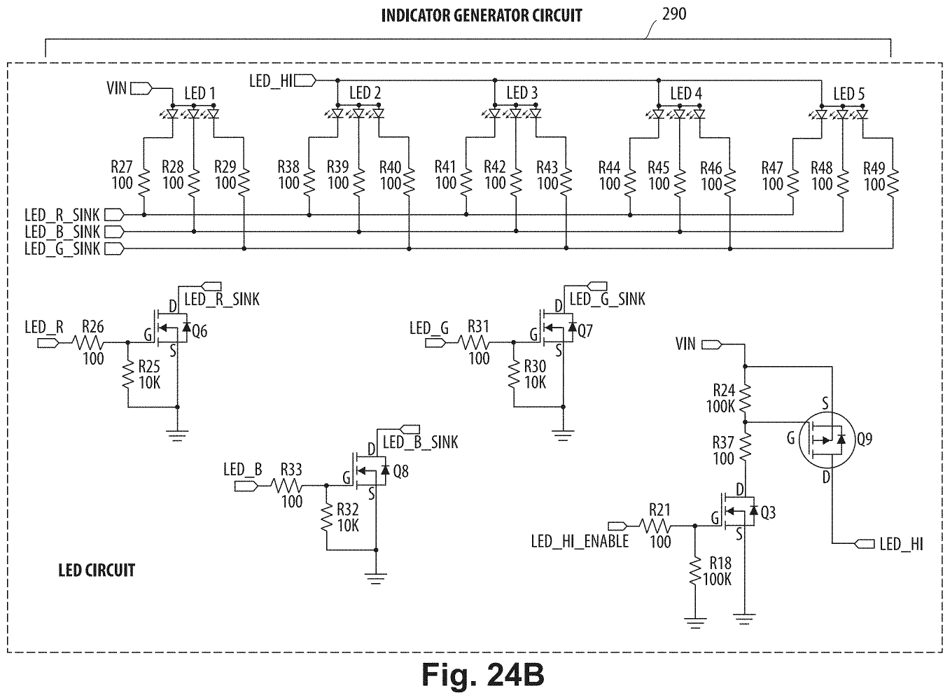

As shown in FIG. 23, the UWB detector circuitry 270 is based on ultra-wide band (UWB) technology and is used for identifying and calculating the distance between the mobile proximity device 50 of a wearer and other mobile proximity devices 50 worn by other wearers, or fixed or secondary proximity devices, to determine if the mobile proximity devices 50 are within the predefined proximity distance or in close proximity as described herein above. Distances measured with ultra-wide band technology are typically accurate within 10-30 cm. In this exemplary embodiment, the UWB detector circuitry 270 includes a UWB wireless transceiver module U3. As a non-limiting example, the UWB wireless transceiver module U3 may be a DWM1001C UWB wireless transceiver module sold by Qorvo. This particular UWB wireless transceiver module integrates a UWB transceiver, a Bluetooth Low Energy (BLE) transceiver. With UWB technology, the UWB wireless transceiver module U3 can associate very precise times with the transmission or reception of the start packet (or start signal). In other words, the UWB wireless transceiver module U3 can timestamp start signals (or packets) and additional signals (or packets). The timestamps can then be used to calculate distance between the mobile proximity device 50 of the wearer and other mobile proximity devices 50 given that radio signals propagate at the speed of light, as described above. The two common topologies of UWB transmissions are Two Way ranging (TWR) and Time Distance of Arrival (TDoA). Generally, as described above, with the TWR topology two nodes, e.g., mobile proximity devices 50, exchange messages between each other. Generally, TDoA is a one-way signal where mobile tags (e.g., mobile proximity devices 50) periodically emit a beacon that is received by fixed-position anchor nodes, e.g., a fixed proximity device 100. Typically, at least three or four anchor nodes, e.g., fixed proximity devices 100, are used to determine the position of a mobile tag, e.g., a mobile proximity device 50. The anchor nodes, e.g., fixed proximity devices 100, which are precisely time-synchronized, typically forward data to the administration system 150 that calculates the position of the mobile proximity devices 50 using multi-lateration based on the time of receipt of radio wave signals and known positions of the anchor nodes, e.g., the fixed proximity devices 100. It is noted that the administrative system 150 may be a local administrative system or an offsite or remote administrative system 150. In the exemplary embodiment shown, the UWB wireless transceiver module U3 uses TWR topology. The software for the UWB wireless transceiver module U3 is used to timestamp signals and calculate the distance between mobile proximity devices 50 within the controlled premises. When another mobile proximity device 50 is detected within the communication range of the first or second mobile proximity devices 50A and 50B, the software activates one or more GPIO pins on the UWB wireless transceiver module U3. It is noted that the software may be configured to support GIPO, SPI and UART data exchange, and gateway interface, and use of the integrated accelerometer to adjust activity when the mobile proximity device is in motion. Thus, the UWB wireless transceiver module U3 with its integrated software can identify whether another mobile proximity device 50 is within the predefined proximity distance to the wearer's mobile proximity device 50. When another mobile proximity device 50 is determined to be within the predefined proximity distance, such data is communicated to the controller circuit 310 for further handling. The address of the mobile proximity device 50 in contact may be transmitted from the UWB wireless transceiver module U3 to the controller circuit 310, for example, by way of UART, initiated by the controller circuit 310 after the initial general purpose input/output (GPIO) signal. A function of the controller circuit 310 is to activate one or more indicators or alarms to advise or warn the wearer that they are within the predefined proximity distance of another mobile proximity device 50. For example, the controller circuit 310, seen in FIGS. 25A and 25B, can supply a PWM signal (Buzz PWM) appropriate to drive the buzzer B1 or other output device at a desired frequency of the indicator generator circuitry 290. The one or more indicators or alarms can be, for example, a piezo buzzer B1, a vibration (haptic) motor M1, and/or one or more visual indicators, e.g., one or more LED's, such as LED1, LED2, LED3, LED4 and LED5, seen in FIGS. 24A and 24B. In the exemplary embodiment shown, the visual indicators are visible via one or more openings 55 in the rear housing portion 56, seen in FIG. 9. However, if the housing 52 is made of a translucent polymer material, the one or more visual indicators, e.g., LED1, LED2, LED3, LED4 and LED5, would be visible through the translucent polymer material. As noted, the mobile proximity device 50 may also include the accelerometer circuitry 320 that works in conjunction with the controller circuitry 310 to detect when the mobile proximity device 50 is stationary or moving. The mobile proximity device 50 may also include an input device, such as a pushbutton switch, that can be used, for example, to switch or mute the indicator device. A mute function may be of a limited time duration so as to not totally defeat the purpose of wearing a mobile proximity device 50.

As described above, the TWR topology generally includes a transceiver that is constantly alert, increasing power usage. To optimize energy usage and the life of the battery 68, the UWB module U3 may be powered during certain times of a day as defined by a schedule. As a non-limiting example, the UWB module U3 can be powered during working hours. In another exemplary embodiment of optimizing energy usage and battery life, power to the UWB module U3 may be turned “on” or “off” in response to motion of the mobile proximity device 50. For example, as noted above, the mobile proximity device 50 may include accelerometer circuitry 320 and the motion of the mobile proximity device 50 as determined by accelerometer would determine whether power to the UWB module U3 is turned “on” or “off” by the controller circuitry 310. For example, if the accelerometer circuitry 320 detects little or no motion of the mobile proximity device 50, power to the UWB module U3 may be turned “off” by the controller circuitry 310 on the presumption that this represents a state where the wearer is no longer wearing the mobile proximity device 50 or is in a fixed location, like an office. In another exemplary embodiment of optimizing energy usage and battery life, power to the UWB module U3 may be turned “on” or “off” in response to motion of the mobile proximity device 50 combined or coordinated with time based scheduling. For example, the mobile proximity device 50 may be programmed to turn power to the UWB module U3 “on” at a certain time in the morning and to turn power to the UWB module U3 “off” after a certain time during the day, but only when the mobile proximity device 50 has been motionless for a period of time. The controller circuit 310 operates off a real time clock or other timer which can be internal or external to the wireless module and processor U1. Based on time and the programmed schedule, the controller circuit 310 can turn the UWB module “on” or “off” It is contemplated that other timer could be used in similar fashion to achieve reduced power consumption from the UWB module U3, such as triggering a sleep state or disabling specific components. The controller circuit 310 itself can conserve energy by operating mostly in sleep mode, waking periodically or when triggered by input from the UWB detector circuitry 270 or by activating a switch S1, seen in FIG. 25B, on the mobile proximity device 50.

Another exemplary embodiment of a TWR operating topology is described. In this exemplary operating topology, an accelerometer is used to determine whether the wearer is moving (walking) or stationary. If stationary, the UWB wireless transceiver module U3 of the UWB detector circuitry 270 and other components, e.g., transceivers and processors, are allowed to sleep or power down to conserve power, and the mobile proximity device 50 can periodically emit a beacon using Bluetooth Low Energy (BLE) transceiver or other known techniques. The mobile proximity device 50 then delays a short time before returning to sleep/idle state. With moving mobile proximity devices 50, as identified by the accelerometer, the controller circuit 310 and at least one transceiver are kept active to listen for beacons from stationary (and other moving) mobile proximity devices 50. If a beacon is detected, and the moving mobile proximity device 50 wishes to perform a ranging operation (based on a thresholding RSSI, mobile proximity device history, or other means) then the moving mobile proximity device 50 may initiate coordination with the other mobile proximity devices 50. By this means, mobile proximity devices 50 that are stationary are allowed to operate in a reduced power state most of the time, as it can be presumed that most mobile proximity device 50 wearers and hence their mobile proximity devices 50 will likely be stationary a majority of the time. Thus, there is the potential for energy savings, and perhaps extending the battery life and/or allowing reductions in mobile proximity device weight and/or cost by using smaller batteries. This also maintains effectiveness at contact detection, since at least one moving mobile proximity device 50 is involved when two mobile proximity devices come into close proximity.

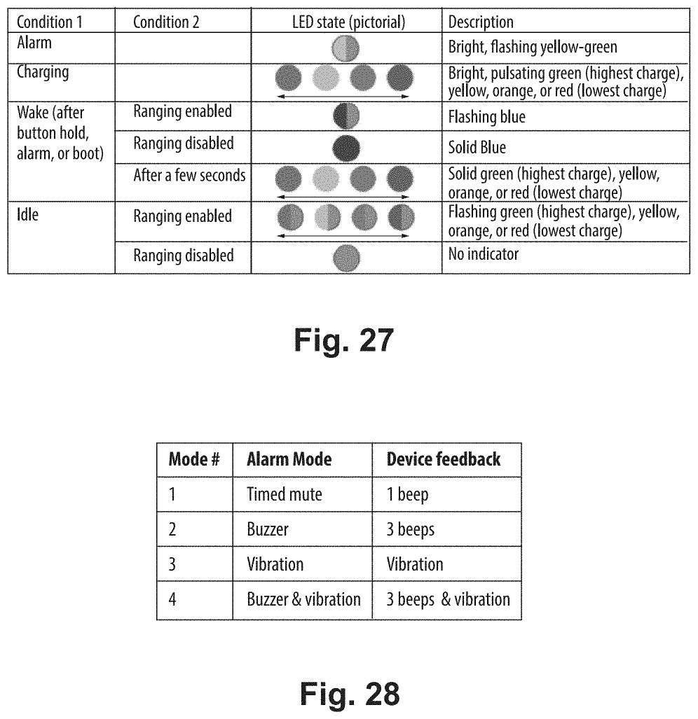

The indicator generator circuitry 290, shown in FIG. 24, may include circuitry to drive visible, audible and/or haptic indicators in the mobile proximity devices 50. In the exemplary embodiment shown, the mobile proximity device 50 may include a buzzer or speaker B1, seen in FIG. 24, used to provide an audio warning or feedback to the wearer of the mobile proximity device 50 that it is within the predefined proximity distance of another mobile proximity device 50. In such an example, the buzzer or speaker B1 may be a piezo device, and the indicator generator circuitry 290 may include a piezo driver circuit U6 that drives the piezo device. In addition, the mobile proximity device 50 may include a haptic device M1, seen in FIG. 24, used to provide haptic warning or feedback to the wearer of the mobile proximity device 50 that it is within the predefined proximity distance of another mobile proximity device 50. In such an example, the haptic device M1 may be a vibration motor, and the indicator generator circuitry 290 may include a vibration motor circuit that in conjunction with the controller circuitry 310 drives the vibration motor M1. In the exemplary embodiment shown, the vibration motor M1 is mounted, e.g., via SMD soldering, adhesive or other means, to the printed circuit board 66 within housing 52 of the mobile proximity device 50. As an alternative, the vibration motor may be mounted to other components, for example the housing 52. FIG. 28 provides an exemplary table of operational alarm modes for the buzzer B1 and the vibration motor M1. The one or more visual indicators, which in this exemplary embodiment includes LED1-LED5, is also mounted to the printed circuit board 66 within housing 52 of the mobile proximity device 50. FIG. 27 provides an exemplary table of operational alarm modes for the one or more visual indicators, e.g., LED1-LED4. In another exemplary embodiment, the LED5, e.g., LED1-LED5, can be controlled to represent different operational states or alarms. For example, only one LED may be illuminated or flashed, or two or more LEDs may be illuminated or flashed. Illuminating one LED may be indicative of the mobile proximity device 50 being in an ordinary charge/operation state. Flashing all five LEDs may be indicative of the mobile proximity device 50 being in an alarms condition. The LEDs may have multiple elements such as multiple colors, e.g. RGB LEDs, and the overall color and intensity may be varied by PWM control of each LED element.

To facilitate setting time as well as data exchange capabilities, the controller circuitry 310 may include a wireless transceiver U1, such as the Synapse SM220 or Espressif ESP32 series wireless transceivers. It is noted, that in a closed environment, fixed wireless nodes, such as the fixed proximity devices 100 described herein, can be deployed to set the time on the mobile proximity devices 50, and to adjust settings within the mobile proximity devices, such as the predefined proximity distance, as determined by the system administrators, or to collect data. Coordination can proceed, for example, with the mobile proximity device's controller circuitry 310 waking at intervals, e.g., every 10 seconds, broadcasting a beacon, and delaying resumption of the sleep mode for a short time. If a fixed node, e.g., a fixed proximity device 100, receives and wishes to respond to a mobile proximity device 50, the mobile proximity device's wake time can be extended by the fixed proximity device 100. In another exemplary embodiment, the fixed proximity device 100 can emit a beacon at a predefined interval, e.g., at 50 ms intervals, that includes the current time. The mobile proximity devices 50 within range of the beacon from the fixed proximity device 100 and within the mobile proximity device's 50 wake interval, could update its internal clock. The mobile proximity device 50 may be programmed to update its internal clock once a day or at any other interval. The emitted beacon from the fixed proximity devices 100 may also include commands prompting the mobile proximity devices 50 to respond for further updates. In another exemplary embodiment, the internal clock may be updated by interaction with the administrative system 150 via the access points 170.

It is noted that the mobile device 50 can be configured to store proximity event data associated with and received from other mobile proximity devices that are detected by the UWB detector circuit 270, in either generalized form, e.g., number of contact violations each hour, or event-specific data, e.g., address of mobile proximity devices contacted with duration and minimum and average distance.

A goal of the mobile proximity devices contemplated by the present disclosure is to mitigate the threat of communicable diseases, such as COVID-19, through a wearable device that is capable of identifying distances between individuals in public, an organization or facility so that individuals wearing such mobile devices can maintain appropriate social distancing. The mobile devices according to the present disclosure identify and encourage proper distancing behavior through various audible alarms or haptic feedback provided to the wearer by the mobile device.

The embodiment(s) described above and illustrated in the figures are presented by way of example only and are not intended as a limitation upon the concepts and principles of the present disclosure. As such, it will be appreciated that variations and modifications to the elements and their configurations and/or arrangement exist within the spirt and scope of one or more independent aspects as described.

What is claimed is:

1. A mobile proximity device comprising:
a housing having a front housing portion, a rear housing portion and at least one cavity for receiving internal components;
a UWB detector circuit within the at least one cavity, the UWB detector circuit being configured to receive signals from at least one other mobile proximity device and for calculating a distance between the mobile proximity device and the at least one other mobile proximity device; and
at least one indicator used to provide at least an audible, haptic or visual indication when the distance between the mobile proximity device and the at least one other mobile proximity device is calculated to be within a predetermined distance.

2. The mobile proximity device according to claim 1, wherein the predetermined distance is between about 1 foot and about 10 feet.

3. The mobile proximity device according to claim 1, further comprising a clip member having a mounting bracket used to affix the clip member to either the front housing portion or the rear housing portion, and a clip used to removably attach the clip member to a wearer of the mobile proximity device.

4. The mobile proximity device according to claim 1, further comprising a bracket attached to the housing and configured to receive a strap or lanyard.

5. The mobile proximity device according to claim 1, wherein the housing is a sealed housing.

6. The mobile proximity device according to claim 1, wherein the UWB detector circuit may be selectively enabled or powered according to a predefined schedule.

7. The mobile proximity device according to claim 1, further comprising accelerometer circuitry to detect if the mobile proximity device is moving or stationary, and when the accelerometer circuitry detects that the proximity device is stationary the mobile proximity device operates in a low power state, and when the accelerometer circuitry detects that the proximity device is moving the mobile proximity device operates in a normal operating state performing calculations of the distance between the mobile proximity device and the at least one other mobile proximity device.

8. The mobile proximity device according to claim 1, wherein a controller circuit within the housing logs each instance where the distance between the mobile proximity device and the at least one other mobile proximity device is calculated to be within the predetermined distance.

9. A mobile proximity device comprising:
a housing having a front housing portion, a rear housing portion and at least one cavity for receiving internal components;
a UWB detector circuit within the at least one cavity, the UWB detector circuit being configured to receive signals from at least one other mobile proximity device and for calculating a distance between the mobile proximity device and the at least one other mobile proximity device;
at least one indicator used to provide at least an audible, haptic or visual indication when the distance between the mobile proximity device and the at least one other mobile proximity device is calculated to be within a predetermined distance; and
a bracket attached to the housing and configured to receive a strap or lanyard.

10. The mobile proximity device according to claim 9, wherein the predetermined distance is between about 1 foot and about 10 feet.

11. The mobile proximity device according to claim 9, further comprising a clip member having a mounting bracket used to affix the clip member to either the front housing portion or the rear housing portion, and a clip used to removably attach the clip member to a wearer of the mobile proximity device.

12. The mobile proximity device according to claim 9, wherein the housing is a sealed housing.

13. The mobile proximity device according to claim 9, wherein the UWB detector circuit may be selectively enabled or powered according to a predefined schedule.

14. The mobile proximity device according to claim 9, further comprising accelerometer circuitry to detect if the mobile proximity device is moving or stationary, and when the accelerometer circuitry detects that the proximity device is stationary the mobile proximity device operates in a low power state, and when the accelerometer circuitry detects that the proximity device is moving the mobile proximity device operates in a normal operating state performing calculations of the distance between the mobile proximity device and the at least one other mobile proximity device.

15. The mobile proximity device according to claim 1, wherein a controller circuit within the housing logs each instance where the distance between the mobile proximity device and the at least one other mobile proximity device is calculated to be within the predetermined distance.

16. A proximity detection system comprising:
a plurality of mobile proximity devices, each of the mobile proximity devices includes:
a housing having a front housing portion, a rear housing portion and at least one cavity for receiving internal components;
a UWB detector circuit within the at least one cavity, the UWB detector circuit being configured to receive signals from at least one other mobile proximity device and for calculating a distance between the mobile proximity device and the at least one other mobile proximity device; and
at least one indicator used to provide at least an audible, haptic or visual indication when a proximity event is detected by the UWB detector circuit, wherein the proximity event is when the distance between the mobile proximity device and the at least one other mobile proximity device is calculated to be within a predetermined distance; and
at least one access point configured to wirelessly communicate with each of the plurality of mobile proximity devices such that each of the plurality of mobile proximity devices transmit to the at least one access point each detected proximity event; and
at least one administrative system configured to wirelessly communicate with the at least one access point such that the at least one access point transmits to the at least one administrative system each detected proximity event.

17. The proximity detection system according to claim 16, wherein the at least one access point comprises a wi-fi access point.

18. The proximity detection system according to claim 16, wherein the predetermined distance is between about 1 foot and about 10 feet.

19. The proximity detection system according to claim 16, further comprising a clip member having a mounting bracket used to affix the clip member to either the front housing portion or the rear housing portion, and a clip used to removably attach the clip member to a wearer of the mobile proximity device.

20. The proximity detection system according to claim 16, further comprising a bracket attached to the housing and configured to receive a strap or lanyard.

21. The proximity detection system according to claim 16, wherein the UWB detector circuit may be selectively enabled or powered according to a predefined schedule.

22. The proximity detection system according to claim 16, further comprising accelerometer circuitry to detect if the mobile proximity device is moving or stationary, and when the accelerometer circuitry detects that the proximity device is stationary the mobile proximity device operates in a low power state, and when the accelerometer circuitry detects that the proximity device is moving the mobile proximity device operates in a normal operating state performing calculations of the distance between the mobile proximity device and the at least one other mobile proximity device.

23. The proximity detection system according to claim 16, wherein a controller circuit within the housing logs each instance where the distance between the mobile proximity device and the at least one other mobile proximity device is calculated to be within a predetermined distance.

24. The proximity detection system according to claim 16, wherein each of the plurality of mobile proximity devices periodically receive commands from the administrative system through the at least one access point.

25. proximity detection system according to claim 16, wherein each of the plurality of mobile proximity devices are configured to allow a wearer to access to controlled areas, facilities, or equipment.
